(19) United States
(12) Patent Application Publication
(10) Pub. No.: US 2024/0248167 A1
(43) Pub. Date: Jul. 25, 2024

(54) WIRELESS COMMUNICATION METHOD AND DEVICE

(71) Applicant: GUANGDONG OPPO MOBILE TELECOMMUNICATION CORP., LTD., Dongguan (CN)

(72) Inventors: Lei HUANG, Singapore (SG); Chaoming LUO, Dongguan (CN); Ning GAO, Dongguan (CN)

(73) Assignee: GUANGDONG OPPO MOBILE TELECMMUNICATIONS CORP., LTD., Dongguan (CN)

(21) Appl. No.: 18/591,843

(22) Filed: Feb. 29, 2024

Related U.S. Application Data
(63) Continuation of application No. PCT/CN2021/118811, filed on Sep. 16, 2021.

(51) Int. Cl. G01S 7/00; G01S 13/86; H04W 24/10; H04W 84/12

(52) U.S. Cl. CPC G01S 7/006; G01S 13/86; H04W 24/10; H04W 84/12

(57) ABSTRACT

A wireless communication method and a device, which can establish a measurement configuration. The method comprises: a first device receiving at least one measurement configuration identifier, which is sent by a second device, wherein each measurement configuration identifier corresponds to a group of operation parameters for perception measurement.

### CROSS REFERENCE TO RELATED APPLICATIONS

The present application is a continuation application of the international patent application No. PCT/CN2021/118811, filed on Sep. 16, 2021, and contents of which are incorporated herein by its entireties.

### TECHNICAL FIELD

The present disclosure relates to the field of communication, and in particular to a wireless communication method and a wireless communication device.

### BACKGROUND

Sensing measurement is a functional enhancement based on the 802.11 protocol proposed by the 802.11bf standard. For the sensing measurement, wireless signals are used to measure and sense a surrounding environment to determine whether someone has intruded into a room, whether someone is moving in a room, whether someone is fallen, and so on; to identify gestures; to create a spatial three-dimensional image, and so on.

A specific negotiation process for establishing a configuration for the sensing measurement has not been discussed in the related art.

### SUMMARY OF THE DISCLOSURE

The present disclosure provides a wireless communication method and a wireless communication device to establish the configuration for the sensing measurement.

In a first aspect, a wireless communication method is provided and includes: receiving, by a first device, at least one measurement configuration identifier sent by a second device; wherein each of the at least one measurement configuration identifier corresponds to a set of operational parameters to perform sensing measurement.

In a second aspect, a wireless communication device is provided and includes a processor and a memory, wherein the memory is configured to store a computer program, the processor is configured to invoke and run the computer program stored in the memory to perform the method of the first aspect and any implementation thereof.

In a third aspect, a wireless communication device is provided and includes a processor and a memory, wherein the memory is configured to store a computer program, the processor is configured to invoke and run the computer program stored in the memory to perform the method of second aspect and any implementation thereof.

According to the above, in a process of establishing a measurement configuration, devices may interact with each other about a measurement configuration identifier corresponding to the to-be-established measurement configuration. The measurement configuration identifier corresponds to a set of operational parameters to be used for performing the sensing measurement. The device can establish, without carrying the set of operational parameters, the measurement configuration based on the operational parameters corresponding to the measurement configuration identifier.

### BRIEF DESCRIPTION OF THE DRAWINGS

FIG. 1 is a schematic view of a communication system architecture according to an embodiment of the present disclosure.

FIG. 2 is a schematic view showing a Wi-Fi sensing process.

FIG. 3 is a flow chart of a wireless communication method according to an embodiment of the present disclosure.

FIG. 4 is an interactive schematic view of a method of establishing measurement configuration according to an embodiment of the present disclosure.

FIG. 5 is an interactive schematic view of a method of establishing measurement configuration according to another embodiment of the present disclosure.

FIG. 6 is a schematic view of a format of a Neighbor Report element in which sensing capability information is carried according to an embodiment of the present disclosure.

FIG. 7 is a schematic view of a format of a RM (radio measurement) Enabled Capabilities element in which the sensing capability information is carried according to an embodiment of the present disclosure.

FIG. 8 is a schematic view of the format of a reduced Neighbor Report element in which sensing capability information is carried according to an embodiment of the present disclosure.

FIG. 9 is a schematic view of a format of an Extended Capabilities element in which the sensing capability information is carried according to an embodiment of the present disclosure.

FIG. 10 is a schematic view of a format of an Extended Capabilities element in which the sensing capability information is carried according to an embodiment of the present disclosure.

FIG. 11 is a schematic view of a frame format in which at least one measurement configuration is carried according to an embodiment of the present disclosure.

FIG. 12 is a schematic view of a format of a sensing session establishment request frame according to an embodiment of the present disclosure.

FIG. 13 is a schematic view of a format of a measurement configuration establishment request frame according to an embodiment of the present disclosure.

FIG. 14 is a schematic view of a format of a sensing session establishment response frame according to an embodiment of the present disclosure.

FIG. 15 is a schematic view of a format of the measurement configuration establishment response frame according to an embodiment of the present disclosure.

FIG. 16 is a schematic view of a format of a sensing session establishment request frame which carries at least one measurement configuration according to an embodiment of the present disclosure.

FIG. 17 is a schematic view of a format of the measurement configuration establishment request frame which carries at least one measurement configuration according to an embodiment of the present disclosure.

FIG. 18 is a schematic view of a wireless communication device according to an embodiment of the present disclosure.

FIG. 19 is a schematic view of another wireless communication device according to an embodiment of the present disclosure.

FIG. 20 is a schematic view of still another a wireless communication device according to an embodiment of the present disclosure.

FIG. 21 is a schematic view of a communication device according to an embodiment of the present disclosure.

FIG. 22 is a schematic view of a chip according to an embodiment of the present disclosure.

FIG. 23 is a schematic view of a communication system according to an embodiment of the present disclosure.

### DETAILED DESCRIPTION

Technical solutions in embodiments of the present disclosure will be described below by referring to the accompanying drawings of the embodiments of the present disclosure. Apparently, the described embodiments are a part of but not all of the embodiments of the present disclosure. All other embodiments, which are obtained by any ordinary skilled person in the art based on the embodiments in the present disclosure without making creative work, shall fall within the scope of the present disclosure.

The technical solutions of the embodiments of the present disclosure may be applied to various communication systems, such as wireless local area network (WLAN), Wireless Fidelity (WiFi), or other communication systems.

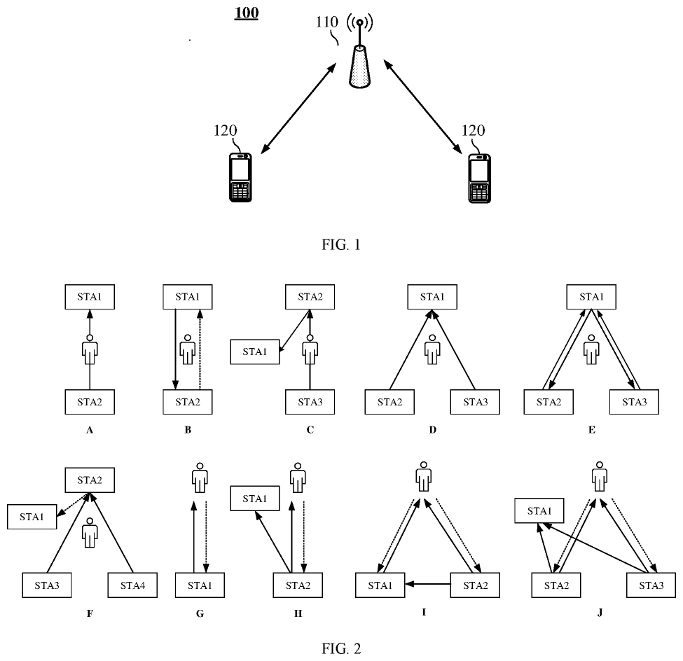

Exemplarily, the communication system 100 applied to the embodiments of the present disclosure is shown in FIG. 1. The communication system 100 may include an access point (AP) 110, and a station (STA) 120 that accesses a network through the AP 110.

In some scenarios, the AP is referred to as an AP STA, i.e., in some cases, the AP is also an STA.

In some scenarios, the STA is referred to as a non-AP STA.

Communication in the communication system 100 may be between the AP and the non-AP STA, between the non-AP STA and the non-AP STA, or between the STA and a peer STA. The peer STA may refer to a device that communicates with the STA from another end. For example, the peer STA may be an AP or a non AP STA.

The AP is equivalent to a bridge that connects a wired network with a wireless network. A main role of the AP is to connect various wireless network clients with each other, and then enables the wireless network to access the Ethernet. The AP device may be a terminal device (such as a mobile phone) or a network device (such as a router) arranged with a Wi-Fi chip.

It shall be understood that a role of the STA in the communication system is not fixed. For example, in some scenarios where the mobile phone is connected to the route, the mobile phone is the non-AP STA; and in a case where the mobile phone serves as a hotspot for other mobile phones, the mobile phone serves as the AP.

Each of the AP and the non-AP STA may be a device applied in an internet of vehicles; an Internet Of Things (IoT) node or a sensor in the IoT; a smart camera, a smart remote, a smart water meter or a smart electricity meter in smart homes, and a sensor in smart cities.

In some embodiments, the non-AP STA may support the 802.11be. The non-AP STA may support the 802.11ax, the 802.11ac, the 802.11n, the 802.11g, the 802.11b, the 802.11a, and various other current and future wireless local area networks (WLANs) of the 802.11 family.

In some embodiments, the AP may be a device that supports the 802.11be, and the AP may be a device that supports the 802.11ax, the 802.11ac, the 802.11n, the 802.11g, the 802.11b, and the 802.11a, and various other current and future WLANs of the 802.11 family.

In the embodiments of the present disclosure, the STA may be a mobile phone, a tablet computer (Pad), a computer, a virtual reality (VR) device, an augmented reality (AR) device, a wireless device in industrial control, a set-top box, a wireless device in self-driving, a vehicle-mounted communication device, a wireless device in remote medical care, a wireless device in smart grid, a wireless device in transportation safety, a wireless device in a smart city, a wireless device in a smart home, a wireless communication chip/ASIC/SOC/and so on, all of which supports the WLAN/Wi-Fi technology.

The WLAN technology may support frequency bands that may include, but are not limited to: low frequency bands (such as 2.4 GHZ, 5 GHZ, 6 GHZ), high frequency bands (such as 60 GHz).

FIG. 1 exemplarily illustrates one AP STA and two non-AP STAs. In some embodiments, the communication system 100 may include a plurality of AP STAs and other numbers of non-AP STAs, which are not limited herein.

It should be understood that, in the present embodiment, a device, which has communication capabilities and is in a network/system, may be referred to as a communication device. Taking the communication system 100 illustrated in FIG. 1 as an example, the communication device may include an access point 110 and a station 120, and the access point 110 and the station 120 both have the communication capabilities. The access point 110 and the station 120 may be specific devices as described above and will not be repeated herein. The communication device may further include other devices in the communication system 100 such as a network controller, a gateway, and other network entities, which will not be limited herein.

It should be understood that the terms “system” and “network” are often used interchangeably herein. The term “and/or” herein is merely a description of an association relationship of associated objects, indicating that three types of relationships can exist. For example, A and/or B means that A is present alone, A and B are present at the same time, and B is present alone. In addition, the character “/” herein generally indicates that the object before the character “or” the object after the character.

It should be understood that the “instruction” mentioned in the embodiments of the present disclosure may be direct instruction, indirect instruction, or indication of an associated relationship between two objects. For example, A instructing B means that A instructs B directly, such as B obtaining information from A; or A instructs B indirectly, such as A instructing C, and B obtaining information from C; or there is an associated relationship between A and B.

In the embodiments of the present disclosure, the term “correspondence” may indicate direct or indirect correspondence between two objects; or an association relationship being present between the two objects; or one object instructing or being instructed by the other object; or one object configuring and being configured by the other object.

In the embodiments of the present disclosure, “predefined” may be achieved by storing corresponding codes, corresponding tables, or other means that may be used to indicate relevant information in advance in a device (such as including the access point and the station). The present disclosure does not limit specific implementation thereof. For example, predefinition may mean definition in a protocol.

In order to facilitate understanding of the technical solutions of the embodiments of the present disclosure, relevant terms of the present disclosure will be described in the following.

An association identifier (AID) is used to identify a terminal that has established association with the access point.

An unassociated ID (UID) is configured to identify a terminal that is not associated with the access point.

A medium access control (MAC) is short for a media access control (MAC) address.

A transmission opportunity (TXOP) refers to a period of time during which a terminal holding the transmission opportunity can initiate one or more transmissions.

WLAN signals are changed due to being scattered and/or reflected when passing through a person or an object, and WLAN Sensing measures the change of the WLAN signals to sense the person or the object in the environment. That is, WLAN Sensing measures and senses the surrounding environment through wireless signals. In this way, WLAN Sensing determines whether someone has intruded into a room, whether someone is moving in a room, whether someone is fallen, and so on; identifies gestures; creates a spatial three-dimensional image, and so on.

WLAN devices that are involved in the WLAN Sensing may include following roles:

A sensing initiator or a sensing session initiator is a device that initiates a sensing session and desires to obtain sensing result(s).

A sensing responder or sensing session responder is a non-sensing initiator that participates in the sensing session.

A sensing transmitter or a sensing signal transmitting device is a device that initiates sensing illumination signals.

A sensing receiver or a sensing signal receiving device is a device that receives the sensing illumination signals.

A sensing processor is a device that processes sensing measurement result(s).

Sensing participants include the sensing initiator, the sensing transmitter, and the sensing receiver.

The WLAN terminal may have one or more roles in one sensing session. For example, the sensing initiator may serve as the sensing initiator only, or serve as the sensing transmitter device, or also serve as the sensing receiver, or also serve as both the sensing transmitter and the sensing receiver.

For example, as shown in A in FIG. 2, a STA1 may be a sensing initiator, a sensing receiver, or a sensing processor. A STA2 may be a sensing transmitter.

In another example, as shown in B in FIG. 2, the STA1 may be the sensing initiator or the sensing transmitter. The STA2 may be the sensing receiver or the sensing processor.

In another example, as shown in C in FIG. 2, the STA1 may be the sensing initiator or a sensing processor. The STA2 may be a sensing receiver. The STA3 may be a sensing transmitter.

In another example, as shown in D in FIG. 2, the STA1 may be the sensing initiator, the sensing receiver, or the sensing processor. The STA2 may be the sensing transmitter. The STA3 may be the sensing transmitter.

In another example, as shown in E in FIG. 2, the STA1 may be the sensing initiator, the sensing transmitter, and the sensing processor. The STA2 may be the sensing receiver. The STA3 may be the sensing receiver.

In another example, as shown in F in FIG. 2, the STA1 may be the sensing initiation. The STA2 may be the sensing receiver or the sensing processor. The STA3 may be the sensing transmitter. The STA4 may be the sensing transmitter. The STA4 may be the sensing transmitter.

In another example, as shown in G in FIG. 2, the STA1 may be the sensing initiator, the sensing transmitter, the sensing receiver, and the sensing processor.

In another example, as shown in H in FIG. 2, the STA1 may be the sensing initiator. The STA2 may be the sensing transmitter, the sensing receiver, and the sensing processor.

In another example, as shown in I in FIG. 2, the STA1 may be the sensing initiator, the sensing transmitter, the sensing receiver, and the sensing processor. The STA2 may be the sensing transmitter and the sensing receiver.

In another example, as shown in J in FIG. 2, the STA1 may be the sensing initiator or the sensing processor. The STA2 may be the sensing transmitter or the sensing receiver. The STA3 may be the sensing transmitter and the sensing receiver. In some embodiments, there may be a plurality of sensing types. For example, for channel state information (CSI)-based sensing, CSI of received sensing measurement signals is processed to obtain a sensing measurement result. In another example, for radar-based sensing, reflective signals of the received sensing measurement signals are processed to obtain a sensing measurement result.

A WLAN sensing session includes one or more of the following stages: a session establishment stage, a sensing measurement stage, a sensing reporting stage, and a session termination stage.

For the session establishment stage, the sensing session is established; a participant of the sensing session and a role of the participant (including the sensing transmitter and the sensing receiver) are identified; and optionally, the parameters are interacted between terminals.

For the sensing measurement stage, sensing measurement is performed, the sensing transmitter transmits sensing signals to the sensing receiver.

For the sensing reporting stage, the measurement result is reported; depending on an application scenario, the sensing receiver may report the measurement result to the sensing initiator.

For the session termination stage, the terminal stops performing the measurement and terminates the sensing session.

In the related art, a specific negotiation process for establishing the sensing measurement configuration has not been disclosed.

Therefore, the present disclosure provides a technical solution for establishing the sensing measurement configuration, so the sensing measurement configuration can be established, and the signaling overhead is reduced.

In order to facilitate understanding of the technical solutions of the embodiments of the present disclosure, the technical solutions of the present disclosure will be described in detail below based on specific embodiments. The above technologies in the related art may be arbitrarily combined with the technical solutions of the embodiments of the present disclosure as optional solutions, and all of the combinations shall fall within the scope of the present disclosure. The embodiments of the present disclosure include at least some of the following technical solutions.

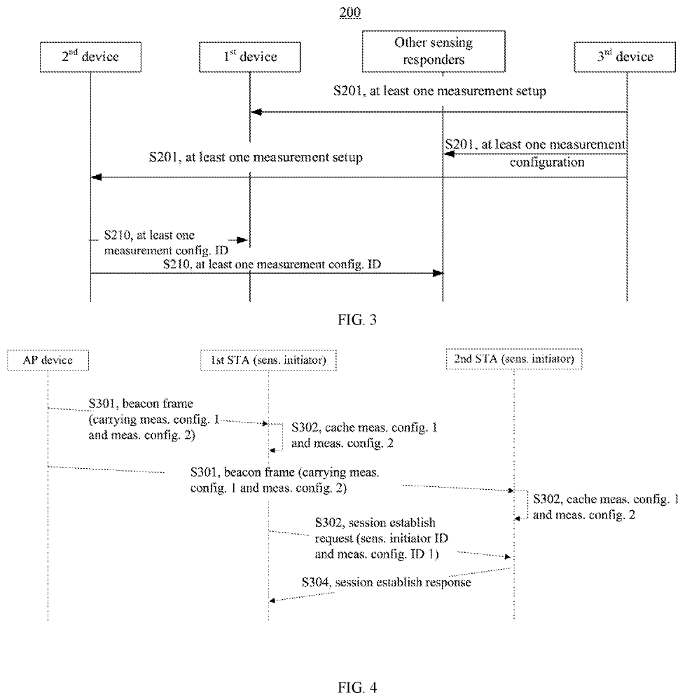

FIG. 3 is a flow chart of a method 200 for wireless communication according to an embodiment of the present disclosure. The method 200, as shown in FIG. 3, includes at least some of the following operations.

In an operation S210, a first device receives at least one measurement configuration identifier sent by a second device. Each measurement configuration identifier corresponds to a set of operational parameters for sensing measurement.

It should be understood that in the embodiments of the present disclosure the measurement may be referred to as the sensing measurement, a measurement configuration may be referred to as a sensing measurement configuration, and a measurement configuration identifier (ID) may be referred to as a sensing measurement configuration ID.

In some embodiments, the first device is a sensing responder.

In some embodiments, when the number of sensing responders is more than one, as shown in FIG. 3, the method 200 further includes the following.

In an operation S220, the second device transmits the at least one measurement configuration identifier to the other sensing responders.

In some embodiments, the second device is the sensing session initiator, or the second device is a proxy device for the sensing session initiator. That is, the sensing session initiator itself may initiate establishment of the measurement configuration, or the measurement configuration can be established through the proxy device.

It should be understood that, in the present embodiment, the sense session initiator may be the AP device or a non-AP STA device. The proxy device of the sense session initiator may be the AP device or a non-AP STA device.

In some embodiments, each measurement configuration identifier is used to identify one measurement configuration. The measurement configuration includes the measurement configuration identifier and a set of operational parameters for the sensing measurement. That is, the measurement configuration identifier may be used to identify the operational parameters corresponding to the measurement configuration.

In the present embodiment, the at least one measurement configuration identifier is used to identify at least one measurement configuration. The at least one measurement configuration may be a measurement configuration that is requested to be established by the sensing session initiator.

In some embodiments, when the second device is the proxy device of the sense session initiator, the sense session initiator may send the at least one measurement configuration identifier to the second device, such that the second device may act as a proxy for the sense session initiator to establish a corresponding measurement configuration based on the at least one measurement configuration identifier.

As an example and not a limitation, the set of operational parameters for a sensing measurement includes at least one of the following:
Role information of a device in the sensing measurement, the number of antennas for the sensing measurement, a bandwidth for the sensing measurement, a type of a measurement result, a type of how to report the measurement result, threshold setting information.

In some embodiments, the role information of a device in the sensing measurement includes one of the following:
Whether the device serves as the sensing receiver in the sensing measurement; and
Whether the device serves as the sensing transmitter in the sensing measurement.

That is, the device serves as the sensing transmitter and/or the sensing receiver in the sensing measurement.

In some embodiments, the number of antennas used for the sensing measurement may refer to the number of antennas that are used to perform the sensing measurement, which may be, such as, any value from 1 to 16.

In some embodiments, the bandwidth used for the sensing measurement may refer to the bandwidth that is used for performing the sensing measurement, which may be, such as, any of 20 MHz, 40 MHz, 80 MHz, 160 MHz, or 320 MHz.

In some embodiments, the type of the measurement result may include at least one of the following:

A channel state information matrix (CSI Matrix), a received signal strength indication (RSSI), a beam signal-to-noise ratio (Beam SNR), a truncated channel impulse response (TCIR), a Signal to Interference plus Noise Ratio (SINR), a reference signal receiving power (RSRP), reference signal receiving quality (RSRQ), and a signal-to-noise ratio (SNR).

It should be understood that, in the present embodiment, the measurement result reported by the sensing receiver may be measurement data obtained by performing the sensing measurement, such as CSI data, RSSI data, and so on; or may be a sensing result obtained by processing the measurement data. For example, for a scenario of detecting the presence of a person, a sensing result thereof may be whether or not a person exists. In another example, for a scenario of detecting the number of persons, a sensing result thereof may be information about the number of persons. In another example, for a scenario of detecting postures, a sensing result thereof may be posture information.

In some embodiments, the type of how to report the measurement result includes:

Whether to immediately report the measurement result, or, whether to delay reporting the measurement result.

In some embodiments, the type of how to report the measurement result includes:

Immediate reporting of the measurement result and delayed reporting of the measurement result.

In some embodiments, the set of operational parameters for the sensing measurement may further include: delay time information for the delayed reporting of the measurement result, such as including a minimum delay time and/or a maximum delay time. The minimum delay time may refer to the device reporting the measurement result after the minimum delay time, and the maximum delay time may refer to the device reporting the measurement result before the maximum delay time.

In some embodiments, if the delay time information for the delayed reporting of the measurement result is not configured, and when the type of how to report the measurement result is immediate reporting of the measurement result, the device may report the measurement result after a short interframe space (SIFS) after the measurement is completed; and when the type of how to report the measurement result is delayed reporting of the measurement result, the device may report the measurement result after a first time length, and the first time length is longer than the SIFS.

In some embodiments, the measurement threshold information includes at least one of the following:

A measurement threshold, a type of a measurement result corresponding to the measurement threshold, whether to report the measurement result based on the measurement threshold, a method of calculating the measurement threshold (such as time reversal resonance energy intensity, scalar difference), a maximum measurement threshold supported by the method of calculating the measurement threshold, and a minimum measurement threshold supported by the method of calculating the measurement threshold.

In practice, the amount of data of a measurement result is usually large. For example, data of the channel state information (CSI) of one measurement may reach 4K˜40K bits. In order to reduce a network load caused by reporting the measurement result, the measurement threshold may be set. When a change between a current sensing measurement result and a previous sensing measurement result is greater than the measurement threshold, the device reports the measurement result; and when the change between the current sensing measurement result and the previous sensing measurement result is not greater than the measurement threshold, the device does not report the measurement result

In an embodiment, the device (including the first device and the second device) stores one or more measurement configurations in advance. That is, the device may be informed of correspondence between the measurement configuration identifier and the operation parameters used for the sensing measurement. In this way, when a sensing setup is to be established subsequently, devices can be informed, by interacting with each other about the measurement configuration identifier, of the operation parameters of the sensing measurement corresponding to the to-be-established measurement configuration and do not need to interact about the specific operation parameters. In this way, the signaling overhead for establishing the measurement configuration is reduced, and a process of establishing the sensing measurement is speeded up.

In some embodiments, the one or more measurement configurations are predefined or may be pre-configured.

In some embodiments, as shown in FIG. 3, the method 200 further includes:

In an operation S201, a third device sends one or more measurement configurations to at least one device. Each measurement configuration includes the measurement configuration ID and an operational parameter for the sensing measurement.

That is, the third device may pre-configure the one or more measurement configurations for the at least one device.

The at least one device, after being informed of the one or more measurement configurations, may cache the one or more measurement configurations for subsequently establishing the measurement configurations.

In some embodiments, the third device may be the AP device or a non-AP STA device, which is not limited herein.

It should be understood that the present disclosure does not limit the number of the at least one device.

In some embodiments, the at least one device includes at least one non-AP STA device and/or at least one AP device.

In some embodiments, the at least one device may include the first device and the second device as previously described.

In some embodiments, the second device and the third device are the same device.

In some embodiments, the first device and the third device are the same device.

In some embodiments, the third device may obtain setups (such as a bandwidth, the number of antennas, the type of the measurement result, the threshold, and so on) of typical operational parameters applicable to various sensing applications (such as gesture recognition, and/or intrusion detection, and/or falling detection) by means of an out-of-band approach. Furthermore, the third device may inform the other devices in the communication system in advance of the setups of the typical operational parameters. In this way, when the sensing initiator requests various sensing participants to participate in the measurement, the sensing initiator can apply the setups of the operational parameters directly. Specifically, different measurement configuration identifiers may indicate different operational parameter setups.

In some embodiments, the third device may send one or more measurement configurations to the at least one device during a discovery phase.

In some embodiments, the one or more measurement configurations are sent via at least one of the following frames:

A beacon frame, a probe response frame, an association response frame, a reassociation response frame.

In some embodiments, the second device may send the at least one measurement configuration identifier to the first device during the sensing establishment stage. For example, the second device may send the at least one measurement configuration identifier when establishing the sensing session or when establishing the measurement configuration.

In an implementation I, the second device sends the at least one measurement configuration identifier to the first device via a first request frame. The first request frame is used to request establishing the sensing session.

That is, the second device, while requesting establishing the sensing session, carries the measurement configuration identifier corresponding to the measurement configuration that is requested to be established.

In some embodiments, the first request frame is referred to as a session-establishment request frame, a sensing session-establishment request frame.

In some embodiments, the first request frame further includes identifier information of the sensing session initiator, such as an AID, UID or a MAC address.

In some embodiments, the first request frame further includes at least one of the following:

An application type corresponding to the to-be-established sensing session, and time-to-live information corresponding to the to-be-established sensing session.

That is, when the second device is requesting establishing the sensing session, the second device may indicate one or more application types (Use Case KPIs) of the sensing session and/or a time to live of the sensing session.

In some embodiments, the application types may include, but are not limited to, at least one of the following:

Detecting presence of a person, detecting the number of persons, detecting a location of the person, detecting posture of the person, detecting vital signs, detecting sleep.

In some embodiments, the sensing session may be terminated explicitly. For example, the sensing session is terminated via a sensing session termination frame. Alternatively, the sensing session may be terminated implicitly. For example, the sensing session is terminated when the time to live of the sensing session is expired.

Therefore, in the present disclosure, when the measurement configuration needs to be established, the sensing session initiator or the proxy device of the sensing session initiator, while establishing the sensing session, may carry the measurement configuration identifier corresponding to the measurement configuration that is requested to be established, without carrying the specific operation parameters corresponding to the measurement configuration. In this way, the signaling overhead for establishing the measurement configuration is reduced, and the process of establishing the measurement configuration may be speeded up.

For an implementation II, the second device sends the at least one measurement configuration identifier to the first device via a second request frame. The second request frame is used to request establishing the measurement configuration.

In some embodiments, the second request frame is referred to as a measurement configuration establishment request frame or a sensing measurement configuration establishment request frame.

In some embodiments, the second request frame further includes identifier information of the sensing session initiator, such as an AID, a UID or a MAC address.

Therefore, in the present, when the measurement configuration needs to be established, the sensing session initiator or the proxy device of the sensing session initiator, while establishing the measurement configuration, may carry the measurement configuration identifier corresponding to the measurement configuration that is requested to be established without carrying the specific operation parameters corresponding to the measurement configuration. In this way, the signaling overhead for establishing the measurement configuration is reduced, and the process of establishing the measurement configuration is speeded up.

It should be understood that the second device may send at least one measurement configuration identifier via the first request frame and/or the second request frame. The measurement configuration identifier that is sent via the first request frame may be the same as or different from the measurement configuration identifier that is sent via the second request frame.

In some embodiments, the method 200 further includes the following.

The first device sends to the second device a response information of the operational parameter corresponding to the at least one measurement configuration identifier.

In some embodiments, one response information corresponds to each measurement configuration. That is, the first device may provide feedback by taking the measurement configuration as granularity; alternatively, a common response information corresponds to all measurement configurations.

In some embodiments, the response information is configured to indicate at least one of the following:

Whether or not the first device agrees with the operational parameter corresponding to the at least one measurement configuration identifier, and a reason of the first device disagreeing with the operational parameter corresponding to the at least one measurement configuration identifier.

As an example, information about reason of the first device disagreeing with the operational parameter corresponding to the at least one measurement configuration identifier may include, but is not limited to, at least one of the following.

The first device does not support the type of the measurement result in the operational parameter. The first device does not support the role information in the operational parameter. The first device does not support bandwidth in the operational parameter. The first device does not support the number of antennas in the operational parameter. The first device does not support the type of how to report the measurement result in the operational parameter. The first device does not support the threshold in the operational parameter.

In some embodiments, the first device sends to the second device, via a first response frame, the response information of the operational parameter corresponding to the at least one measurement configuration identifier. The first response frame is a response frame for the first request frame.

In some embodiments, the first response frame is referred to as a session establishment response frame or a sensing session establishment response frame.

In some embodiments, the first device sends to the second device, via a second response frame, the response information of the operational parameter corresponding to the at least one measurement configuration identifier. The second response frame is a response frame for the second request frame.

In some embodiments, the second response frame is referred to as a measurement configuration establishment response frame or a sensing measurement configuration establishment response frame.

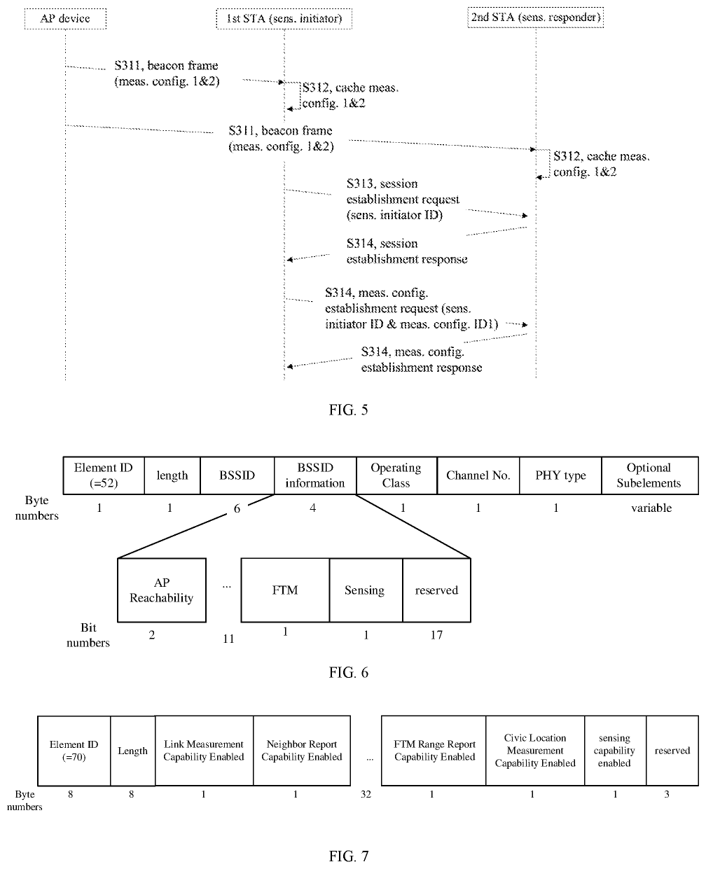

As shown in FIG. 4 and FIG. 5, the method of establishing the measurement configuration will be illustrated based on an example where the third device serves as the AP device, the sensing initiator serves as a first station (corresponding to the second device), and the sensing responder serves as a second station (corresponding to the first device). Operations shown in FIG. 4 correspond to the above-mentioned implementation I, and operations shown in FIG. 5 correspond to the above-mentioned implementation II.

As shown in FIG. 4, following operations may be included.

In an operation S301, the AP device broadcasts one or more measurement configurations (including a measurement configuration 1 and a measurement configuration 2) via a beacon frame.

The measurement configuration 1 includes the measurement configuration identifier 1 and an operational parameter corresponding to the measurement configuration identifier 1. The measurement configuration 2 includes a measurement configuration identifier 2 and an operational parameter corresponding to the measurement configuration identifier 2.

Alternatively, the AP device may send the one or more measurement configurations via a probe response frame, an association response frame, or a re-association response frame.

In an operation S302, devices, such as the first station, the second station, and so on, may receive the beacon frame, obtain the measurement configuration 1 and the measurement configuration 2, and cache the measurement configuration 1 and the measurement configuration 2.

Further, the first station, serving as the sensing initiator, desires to establish the measurement configuration 1.

In an operation S303, the first station sends the session establishment request frame to the second station. The session establishment request frame includes a measurement configuration identifier corresponding to the measurement configuration 1, i.e., a measurement configuration identifier 1, and further includes an identifier of the sensing initiator.

In an operation S304, the second device replies a session establishment response frame to the first device. The session establishment request frame includes a response information for establishing the measurement configuration, such as whether or not to agree with the measurement configuration 1.

As shown in FIG. 5, the following operations may be included.

In an operation S311, the AP device broadcasts one or more measurement configurations (including the measurement configuration 1 and the measurement configuration 2) via the beacon frame.

The measurement configuration 1 includes the measurement configuration identifier 1 and the operation parameter corresponding to the measurement configuration identifier 1. The measurement configuration 2 includes the measurement configuration identifier 2 and the operation parameter corresponding to the measurement configuration identifier 2.

Alternatively, the AP device may send one or more measurement configurations via the probe response frame, the association response frame, or the re-association response frame.

In an operation S312, devices, such as the first station, the second station, and so on, receive the beacon frame, obtain the measurement configuration 1 and the measurement configuration 2, and cache the measurement configuration 1 and the measurement configuration 2.

In an operation S313, the first station sends the session establishment request frame to the second station. The session establishment request frame is configured to request establishing the sensing session. The session establishment request frame includes the identifier of the sensing initiator.

In an operation S314, the second device replies the session establishment response frame to the first device.

Further, the first station desires to establish the measurement configuration 1.

In an operation S315, the first station sends the measurement configuration establishment request frame to the second station. The measurement configuration establishment request frame includes the measurement configuration identifier corresponding to the measurement configuration 1, i.e., the measurement configuration identifier 1, and further includes the identifier of the sensing initiator.

In an operation S316, the second device replies the measurement configuration establishment response frame to the first device. The measurement configuration establishment request frame includes the response information for establishing the measurement configuration, such as whether or not to agree with the measurement configuration 1.

It should be understood that the present disclosure does not limit a sequence in which the AP device sends the measurement configuration to the first station and the AP device sends the measurement configuration to the second station. For example, the AP device may send one or more measurement configurations by broadcasting, or send one or more measurement configurations by unicasting or multicasting. FIG. 4 and FIG. 5 are illustrated based on an example in which the AP device sends the measurement configurations by broadcasting, but the present disclosure is not limited thereto.

It should also be understood that the operations (S301, S302, S311, and S312) in FIG. 4 and FIG. 5 having the same serial numbers may be performed at the same time or may be performed separately, which will not be limited by the present disclosure.

In some embodiments, devices may interact with each other about sensing capability information during the discovery stage.

In some embodiments, the method 200 further includes the following.

The third device receives sensing capability information sent by at least one device.

The sensing capability information from the at least one device may be configured to determine the at least one measurement configuration.

In some embodiments, the sensing capability information includes at least one of the following:

Whether the device supports the sensing measurement (or, whether the device supports sensing), whether the device has enabled sensing capability, role information supported by the device for the sensing measurement, the type of the reported measurement result supported by the device, the maximum number of antennas supported by the device, and the maximum bandwidth supported by the device.

The role information supported by the device for the sensing measurement and the type of the reported measurement result supported by the device may be referred to the above embodiments and will not be repeated herein.

In some embodiments, the sensing capability information is carried in at least one of the following elements:

A neighbor report element, a radio measurement enabled capabilities element, a reduced neighbor report element, and an extended capabilities element.

For example, one or more reserved bits of the above elements are used to carry the sensing capability information of the device.

FIG. 6 is a schematic view of a format of the neighbor report element in which sensing capability information is carried according to an embodiment of the present disclosure.

As shown in FIG. 6, the neighbor report element includes a “whether sensing is supported” field and is configured to indicate whether or not the device supports the sensing or supports the sensing measurement.

In an example, the “whether sensing is supported” field is set to 1 to indicate that the device supports the sensing; and the “whether sensing is supported” field is set to 0 to indicate that the device does not support the sensing.

In another example, the “whether sensing is supported” field is set to 0 to indicate that the device supports the sensing; and the “whether sensing is supported” field is set to 1 to indicate that the device does not support the sensing.

FIG. 7 is a schematic view of a format of the radio measurement enabled capabilities element in which the sensing capability information is carried according to an embodiment of the present disclosure. As shown in FIG. 7, the radio measurement enabled capabilities element includes a field of whether the sensing capability is enabled and is configured to indicate whether the device has enabled the sensing capability or indicate whether the device has enabled the sensing measurement capability.

In an example, the field of whether the sensing capability is enabled is set to 1 to indicate that the device has enabled the sensing capability; and the field of whether the sensing capability is enabled is set to 0 to indicate that the device has not enabled the sensing capability.

In another example, the field of whether the sensing capability is enabled is set to 0 to indicate that the device has enabled the sensing capability; and the field of whether the sensing capability is enabled is set to 1 to indicate that the device has not enabled the sensing capability.

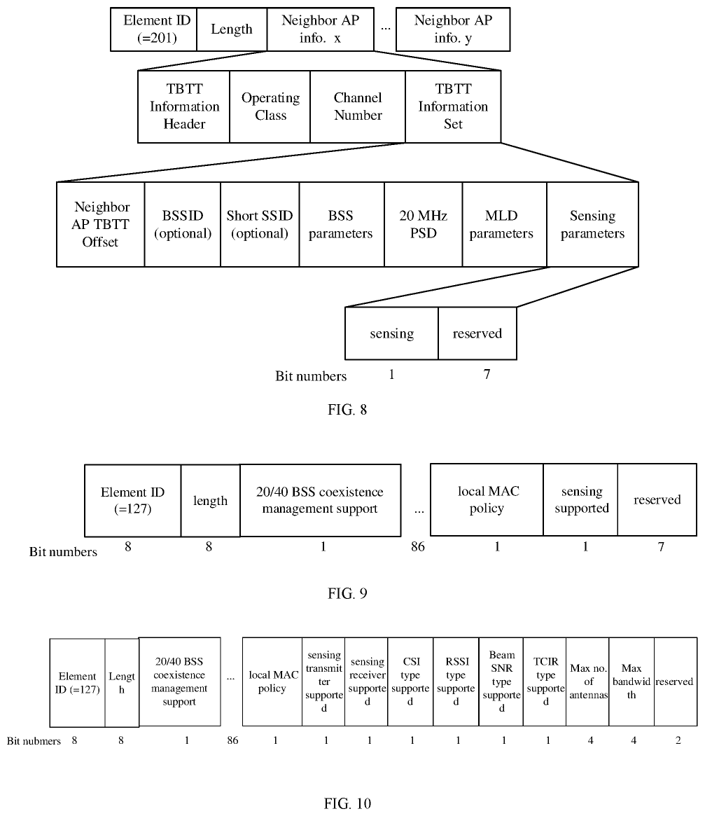

FIG. 8 is a schematic view of a reduced neighbor report element carrying the sensing capability information. As shown in FIG. 8, the reduced neighbor report element includes a field of whether the sensing is supported and is configured to indicate whether or not the device supports the sensing or whether or not the device supports the sensing measurement.

In an example, the field of whether the sensing is supported is set to 1 to indicate that the device supports the sensing; and the field of whether the sensing is supported is set to 0 to indicate that the device does not support the sensing.

In another example, the field of whether the sensing is supported is set to 0 to indicate that the device supports the sensing; and the field of whether the sensing is supported is set to 1 to indicate that the device does not support the sensing.

FIG. 9 is a schematic view of the extended capabilities element carrying the sensing capability information. As shown in FIG. 9, the extended capabilities element includes a field of whether the sensing is supported and is configured to indicate whether or not the device supports the sensing or whether or not the device supports the sensing measurement.

As an example, the field of whether the sensing is supported is set to 1 to indicate that the device supports the sensing; and the field of whether the sensing is supported is set to 0 to indicate that the device does not support the sensing.

In another example, the field of whether the sensing is supported is set to 0 to indicate that the device supports the sensing; and the field of whether the sensing is supported is set to 1 to indicate that the device does not support the sensing.

FIG. 10 is a schematic view of the extended capabilities element carrying the sensing capability information.

It should be understood that the number of bits occupied by each field in FIG. 10 may be determined based on a size of information that actually needs to be carried, which will not be limited by the present disclosure.

It should also be understood that correspondence between a meaning and a value of each field in FIG. 10 is only exemplary, as long as one meaning corresponds to one value only, which will not be limited herein.

As shown in FIG. 10, the extended capabilities element includes at least one of the following fields:

A field of whether the role as the sensing transmitter being supported is configured to indicate whether the device supports the role of being the sensing transmitter.

In an example, the field of whether the role as the sensing transmitter being supported is set to 1 to indicate that the device supports the role as the sensing transmitter. The field of whether the role as the sensing transmitter being supported is set to 0 to indicate that the device does not support the role as the sensing transmitter.

In another example, the field of whether the role as the sensing transmitter being supported is set to 0 to indicate that the device supports the role as the sensing transmitter. The field of whether the role as the sensing transmitter being supported is set to 1 to indicate that the device does not support the role as the sensing transmitter.

A field of whether the role as the sensing receiver being supported is included and is configured to indicate whether the device supports the role as the sensing receiver.

In an example, the field of whether the role as the sensing receiver being supported is set to 1 to indicate that the device supports the role as the sensing receiver; and the field of whether the role as the sensing receiver being supported is set to 0 to indicate that the device does not support the role as the sensing receiver.

In another example, the field of whether the role as the sensing receiver being supported is set to 0 to indicate that the device supports the role as the sensing receiver; and the field of whether the role as the sensing receiver being supported is set to 1 to indicate that the device does not support the role as the sensing receiver.

A field of whether the CSI type being supported is included and is configured to indicate whether the device supports reporting the measurement result in the CSI type.

In an example, the field of whether the CSI type being supported is set to 1 to indicate that the device supports reporting the measurement result in the CSI type; and the field of whether the CSI type being supported is set to 0 to indicate that the device does not support reporting the measurement result in the CSI type.

In another example, the field of whether the CSI type being supported is set to 0 to indicate that the device supports reporting the measurement result in the CSI type; and the field of whether the CSI type being supported is set to 1 to indicate that the device does not support reporting the measurement result in the CSI type.

A field of whether the RSSI type being supported is included and is configured to indicate whether the device supports reporting the measurement result in the RSSI type.

In an example, the field of whether the RSSI type being supported is set to 1 to indicate that the device supports reporting the measurement result in the RSSI type; and the field of whether the RSSI type being supported is set to 0 to indicate that the device does not support reporting the measurement result in the RSSI type.

In another example the field of whether the RSSI type being supported is set to 0 to indicate that the device supports reporting the measurement result in the RSSI type; and the field of whether the RSSI type being supported is set to 1 to indicate that the device does not support reporting the measurement result in the RSSI type.

A field of whether a beam SNR type being supported is included and is configured to indicate whether the device supports reporting the measurement result in the beam SNR type.

In an example, the field of whether a beam SNR type being supported is set to 1 to indicate that the device supports reporting the measurement result in the beam SNR type; and the field of whether a beam SNR type being supported is set to 0 to indicate that the device does not support reporting the measurement result in the beam SNR type.

In another example, the field of whether a beam SNR type being supported is set to 0 to indicate that the device supports reporting the measurement result in the beam SNR type; and the field of whether a beam SNR type being supported is set to 1 to indicate that the device does not support reporting the measurement result in the beam SNR type.

A field of whether a TCIR type being supported field is included and is configured to indicate whether the device supports reporting the measurement result in the TCIR type.

In an example, the field of whether a TCIR type being supported field is set to 1 to indicate that the device supports reporting the measurement result in the TCIR type; and the field of whether a TCIR type being supported field is set to 0 to indicate that the device does not support reporting the measurement result in the TCIR type.

In another example, the field of whether a TCIR type being supported field is set to 0 to indicate that the device supports reporting the measurement result in the TCIR type; and the field of whether a TCIR type being supported field is set to 1 to indicate that the device does not support reporting the measurement result in the TCIR type.

A max-number-of-antenna field is included and is configured to indicate the maximum number of antennas supported by the device, such as 1 to 16 antennas.

A max-bandwidth field is included and is configured to indicate the maximum bandwidth supported by the device.

In an example, 1 indicates 20 MHz, 2 indicates 40 MHz, 3 indicates 80 MHz, 4 indicates 160 MHz, and 5 indicates 320 MHz.

In some embodiments, the neighbor report element is included in at least one of the following frames:
A neighbor report response frame, a millimeter wave device beacon frame (DMG beacon), an authentication frame, an association response frame, a re-association response frame, a fine timing measurement range request frame, a Basic Service Set (BBS) transition management query frame, a BBS transition management request frame, a BBS transition management response frame, and an access network query protocol response frame.

In some embodiments, the radio measurement enabled capabilities element is carried in at least one of the following:

The neighbor report element, the beacon frame, the probe response frame, the association request frame, the association response frame, the reassociation request frame, the reassociation response frame, the millimeter wave device beacon frame.

In some embodiments, the reduced neighbor report element is carried in at least one of the following frames:

The beacon frame, the probe response frame, a fast initiate link setup discovery (FILS discovery) frame.

In some embodiments, the extended capabilities element is carried in at least one of the following frames:

The beacon frame, the probe request frame, the probe response frame, the association request frame, the association response frame, the reassociation request frame, and the reassociation response frame.

Design of the format of the frame carrying the at least one measurement configuration is illustrated in FIG. 11.

That is, the third device may apply the frame format in FIG. 11 to indicate the at least one measurement configuration. The frame format may be applied to any of: the beacon frame, the detection response frame, the association response frame, and the re-association response frame.

It should be understood that a structure, a size, and a name of each field in FIG. 11 are examples only, and other frame formats obtained by transforming the frame format according to the present disclosure shall fall within the scope of the present disclosure. The present disclosure is not limited thereto.

As shown in FIG. 11, the frame may include at least one measurement configuration identifier field and a measurement information field corresponding to each measurement configuration identifier. The measurement configuration identifier field is configured to indicate the measurement configuration identifier, and the measurement information field is configured to indicate an operational parameter corresponding to the measurement configuration identifier, or in other words, an operational parameter corresponding to the measurement configuration.

Further, the measurement information field may include at least one of the following fields.

A field of whether the device being the sensing receiver is included and is configured to indicate whether the peer device is the sensing receiver during the measurement.

In an example, the field of whether the device being the sensing receiver is set to 1 to indicate that the peer device is the sensing receiver during the measurement; and the field of whether the device being the sensing receiver is set to 0 to indicate that the peer device is not the sensing receiver during the measurement. Alternatively, the field of whether the device being the sensing receiver is set to 0 to indicate that the peer device is the sensing receiver during the measurement; and the field of whether the device being the sensing receiver is set to 1 to indicate that the peer device is not the sensing receiver during the measurement.

A field of whether the device being the sensing transmitter is included and is configured to indicate whether a peer device is the sensing transmitter during the measurement.

In an example, the field of whether the device being the sensing transmitter is set to 1 to indicate that the peer device is the sensing transmitter during the measurement; and the field of whether the device being the sensing transmitter is set to 0 to indicate that the peer device is not the sensing transmitter during the measurement. Alternatively, the field of whether the device being the sensing transmitter is set to 0 to indicate that the peer device is the sensing transmitter during the measurement; and the field of whether the device being the sensing transmitter is set to 1 to indicate that the peer device is not the sensing transmitter during the measurement.

A field of whether to delay reporting of the measurement result is included and is configured to indicate whether the peer device delays reporting of the measurement result.

In an example, the field of whether to delay reporting the measurement result is set to 1 to indicate that the peer device delays reporting of the measurement result; and the field of whether to delay reporting the measurement result is set to 0 to indicate that the peer device reports the measurement result without delay. Alternatively, the field of whether to delay reporting the measurement result is set to 0 to indicate that the peer device delays reporting of the measurement result; and the field of whether to delay reporting the measurement result is set to 1 to indicate that the peer device reports the measurement result without delay.

A field of whether the measurement being threshold based is included and is configured to indicate whether the measurement is a threshold-based measurement.

In an example, the field of whether the measurement being threshold based is set to 1 to indicate that the measurement is a threshold-based measurement; and the field of whether the measurement being threshold based is set to 0 to indicate that the measurement is not a threshold-based measurement. Alternatively, the field of whether the measurement being threshold based is set to 0 to indicate that the measurement is a threshold-based measurement; and the field of whether the measurement being threshold based is set to 1 to indicate that the measurement is not a threshold-based measurement.

A report type field is included and is configured to indicate a data type of the measurement result.

In an example, the report type field is set to 0 to indicate the CSI type, the report type field is set to 1 to indicate the RSSI type, the report type field is set to 2 to indicate the beam SNR type, the report type field is set to 3 to indicate the TCIR type, and so on.

A minimum delay time field is included and is configured to indicate that the peer device needs to report the sensing result after the minimum delay time.

In an example, the minimum delay time field is set to 0 to indicate 1 SIFS; the minimum delay time field is set to 1 to indicate 2 SIFS; the minimum delay time field is set to 3 to indicate 4 SIFS; the minimum delay time field is set to 4 to indicate 8 SIFS; the minimum delay time field is set to 5 to indicate one time unit (TU, generally 1 ms); the minimum delay time field is set to 6 to indicate 2 TUs, and so on.

A maximum delay time field is included and is configured to indicate that the peer device needs to report the sensing result before the maximum delay time and does not report any measurement result generated later than the maximum delay time. In some embodiments, the device may discard the measurement result that is generated later than the maximum delay time.

In an example, the maximum delay time field is set to 0 to indicate 1 SIFS; the maximum delay time field is set to 1 to indicate 2 SIFS; the maximum delay time field is set to 3 to indicate 4 SIFS; the maximum delay time field is set to 4 to indicate 8 SIFS; the maximum delay time field is set to 5 to indicate 1 TU; and the maximum delay time field is set to 6 to indicate 2 TUs, and so on.

A number-of-antenna field is included and is configured to indicate the number of antennas for the measurement, such as 1 to 16 antennas.

A bandwidth field is included and is configured to indicate the bandwidth used for the measurement.

In an example, the bandwidth field is set to 1 to indicate 20 MHz; the bandwidth field is set to 2 to indicate 40 MHz; the bandwidth field is set to 3 to indicate 80 MHz; the bandwidth field is set to 4 to indicate 160 MHz; and the bandwidth field is set to 5 to indicate 320 MHz.

A method-of-computing field is included and is configured to indicate a method of computing the threshold.

In an example, the method-of-computing field is set to 0 to indicate time-reversal resonating strength (TRRS); the method-of-computing field is set to 1 to indicate scalar differential, and so on.

A threshold field is included and is configured to indicate threshold data.

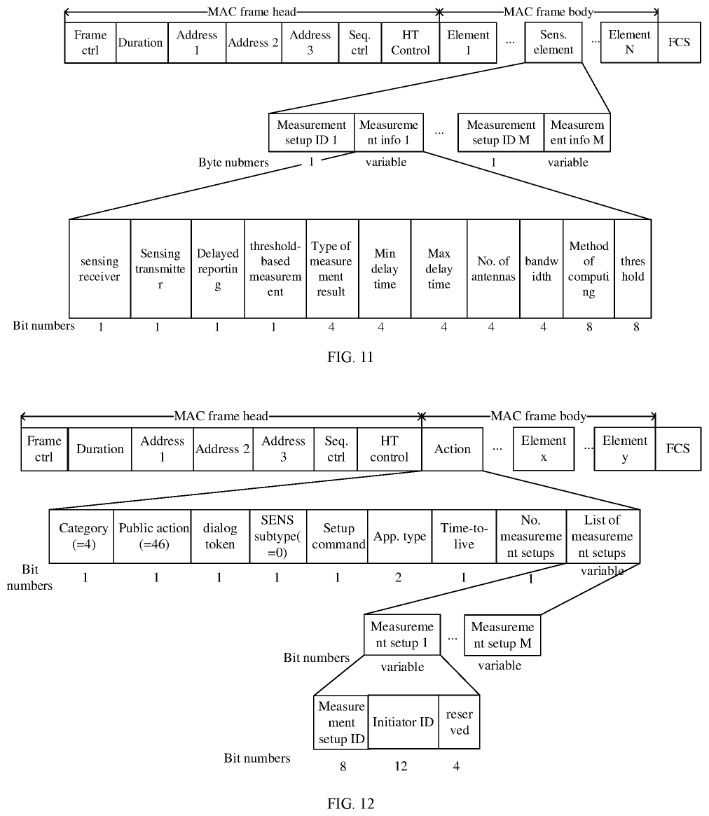

In the following, frame formats of the above-mentioned first request frame, the second request frame, the first response frame, and the second response frame will be described by referring to FIG. 12-FIG. 15.

It should be understood that, a structure, a size, and a name of each field in FIG. 12-FIG. 15 are only examples, and other frame formats obtained by transforming the frame formats according to the examples shall fall within the scope of the present disclosure, and the present disclosure is not limited thereto.

In some embodiments, the first request frame is an action frame or an action no acknowledgement (ACK) frame. That is, the sensing session establishment request frame may be the action frame or the action no ACK frame.

In some embodiments, the first response frame is an action frame or an action no ACK frame.

That is, the sensing session establishment response frame may be the action frame or the action no Ack frame.

In some embodiments, the second request frame is an action frame or an action No ACK frame. That is, the measurement configuration establishment request frame may be the action frame or an action no ACK frame.

In some embodiments, the second response frame is an action frame or an action no ACK frame.

That is, the measurement configuration establishment response frame may be the action frame or the action no ACK frame.

In some embodiments, each of the first request frame, the first response frame, the second request frame, and the second response frame may be considered as a sensing action frame.

In some embodiments, at least one of field in the action frame or in the action no ACK frame may be configured to indicate that the action frame or the action no ACK frame is the sensing session establishment request frame, the sensing session establishment response frame, the measurement configuration establishment request frame, or the measurement configuration establishment response frame.

In some embodiments, the action frame or the action no ACK frame includes an action field. The action field includes an action category field, a public action field, and a SENS subtype field. A value of the action category field, a value of the public action field, and a value of the SENS subtype field may be used cooperatively to indicate that the action frame or the action no ACK frame is the sensing session establishment request frame, the sensing session establishment response frame, the measurement configuration establishment request frame or the measurement configuration establishment response frame.

In an example, the action category field is set to 4 to indicate that the frame is the public action frame. The public action field is set to a reserved value (such as any value in a range of 46 to 255, hereinafter, 46 is taken as an example) to indicate that the frame is the sensing action frame. Further, the SENS Subtype field is set to a value to indicate that the sensing action frame is the sensing session establishment request frame, the sensing session establishment response frame, the measurement configuration establishment request frame, or the measurement configuration establishment response frame.

For example, the SENS Subtype field is set to a first value to indicate that the sensing action frame is the sensing session establishment request frame. The SENS Subtype field is set to a second value to indicate that the sensing action frame is the sensing session establishment response frame. The SENS Subtype field is set to a third value to indicate that the sensing action frame is the measurement configuration establishment request frame. The SENS Subtype field is set to a fourth value to indicate that the sensing action frame is the measurement configuration establishment response frame. Any two of the first value, the second value, the third value, the fourth value are different from each other.

In an example, the first value is 0, the second value is 1, the third value is 2, and the fourth value is 3.

FIG. 12 is a schematic frame format of the sensing session establishment request frame according to an embodiment of the present disclosure.

In the present frame format, the action category field takes a value of 4 to indicate that the frame is the public action frame. The public action field takes a value of 46 to indicate that the frame is the sensing action frame. The SENS subtype field takes a value of 0 to indicate that the frame is the sensing session establishment request frame.

In some embodiments, as shown in FIG. 12, the sensing session establishment request frame may further include at least one of the following fields:

It should be understood that the correspondence between the meaning and the value of each field is only exemplary, as long as each meaning corresponds to one value, and the present disclosure is not limited thereto.

The setup command field is configured to indicate whether the measurement configuration in the sensing session establishment request frame is requested to be established by demands or by suggests. In an example, the setup command field takes a value of 0 to indicate that the measurement configuration is requested to be established by demands; and the setup command field takes a value of 1 to indicate that the measurement configuration is requested to be established by suggests.

An application type field is configured to indicate an application type of the sensing session.

In an example, the application type field takes a value of 0 to indicate detecting presence of a person; the application type field takes a value of 1 to indicate detecting the number of persons; the application type field takes a value of 2 to indicate detecting a location of the person; the application type field takes a value of 3 to indicate detecting posture of the person; the application type field takes a value of 4 to indicate detecting vital signs; and the application type field takes a value of 5 to indicate detecting sleeping.

A time-to-live field is configured to indicate a time-to-live length of the session. When the time-to-live length is expired, the session is terminated automatically.

In an example, the time-to-live field takes a value of 1 to indicate 1 minute; the time-to-live field takes a value of 2 to indicate 10 minutes; the time-to-live field takes a value of 3 to indicate 1 hour; the time-to-live field takes a value of 4 to indicate 12 hours; and so on.

A number-of-measurement field is configured to indicate the number of measurement configurations included in a measurement configuration list field.

A measurement configuration field includes the measurement configuration identifier field and the sensing initiator identifier field.

The measurement configuration identifier (ID) field indicates the identifier of the measurement configuration.

The sensing initiator identifier field indicates the identifier of the sensing initiator, such as an AID or a UID.

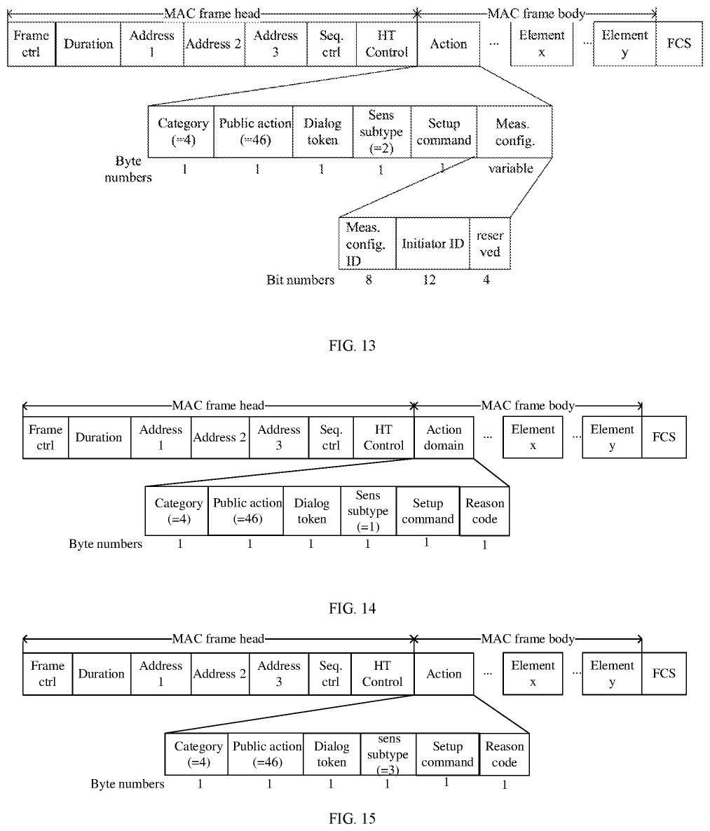

FIG. 13 is a schematic frame format of the measurement configuration establishment request frame according to an embodiment of the present disclosure. In the present frame format, the action category field takes a value of 4 to indicate that the frame is the public action frame. The public action field takes a value of 46 to indicate that the frame is the sensing action frame. The SENS subtype field takes a value of 2 to indicate that the frame is the measurement configuration establishment request frame.

In some embodiments, as shown in FIG. 13, the measurement configuration establishment request frame may further include at least one of the following fields.

It should be understood that the correspondence between the meaning and the value of each field is only exemplary, as long as each meaning corresponds to one value, and the present disclosure is not limited thereto.

The sensing setup command field is configured to indicate how the measurement configuration in the sensing session establishment request frame is configured. In an example, the sensing setup command field takes a value of 0 to indicate that the measurement configuration is configured by demands; and the sensing setup command field takes a value of 1 to indicate that the measurement configuration is configured by suggests.

The measurement configuration field includes the measurement configuration identifier field and the sensing initiator identifier field.

The measurement configuration ID field indicates the identifier of the measurement configuration.

The sense initiator identifier field indicates the identifier of the sensing initiator, such as an AID or a UID, and so on.

According to the frame format shown in FIG. 12 and FIG. 13, when requesting establishing the measurement configuration, the measurement configuration identifier corresponding to the measurement configuration that is requested to be established may be the only information that is carried, and the specific operational parameters may not be carried.

FIG. 14 is a schematic frame format of the sensing session establishment response frame according to an embodiment of the present disclosure. In the present frame format, the action category field takes the value of 4 to indicate that the frame is the public action frame. The public action field takes a value of 46 to indicate that the frame is the sensing action frame. The SENS subtype field takes the value of 1 to indicate that the frame is the sensing session establishment response frame.

In some embodiments, as shown in FIG. 14, the sensing session establishment response frame may include at least one of the following fields.

It should be understood that the correspondence between the meaning and the value of each field is only exemplary, as long as each meaning corresponds to one value, and the present application is not limited thereto.

The sensing setup command field indicates whether to accept the measurement configuration requested in the sensing session establishment request frame.

In an example, the sensing setup command field takes a value of 0 to indicate that the measurement configuration requested in the sensing session establishment request frame is accepted; and the sensing setup command field takes a value of 1 to indicate that the measurement configuration requested in the sensing session establishment request frame is rejected.

A reason code field is configured to indicate a reason of the device disagreeing with the measurement configuration in the sensing session establishment request frame.

The reason code field is present when the value of the sensing setup command indicates that the measurement configuration is rejected. When the value of the sensing setup command indicates that the measurement configuration is accepted, the reason code field is not present.

In an example, the reason code field takes a value of 0 to indicate that the type of the measurement result corresponding to the measurement configuration requested in the sensing session establishment request is not supported. The reason code field takes a value of 1 to indicate that the role corresponding to the measurement configuration requested in the sensing session establishment request is not supported. The reason code field takes a value of 2 to indicate that the bandwidth corresponding to the measurement configuration requested in the sensing session establishment request is not supported. The reason code field takes a value of 3 to indicate that the number of antennas corresponding to the measurement configuration requested in the sensing session establishment request is not supported.

FIG. 15 is a schematic frame format of the measurement configuration establishment response frame according to an embodiment of the present disclosure. In the present frame format, the action category field takes the value of 4 to indicate that the frame is the public action frame. The public action field takes the value of 46 to indicate that the frame is the sensing action frame. The SENS subtype field takes the value of 3 to indicate that the frame is the measurement configuration establishment response frame.

In some embodiments, as shown in FIG. 15, the measurement configuration establishment response frame may further include at least one of the following fields.

It should be understood that the correspondence between the meaning and the value of each field is only exemplary, as long as each meaning corresponds to one value, and the present disclosure is not limited thereto.

The sensing setup command field is configured to indicate whether to accept the measurement configuration that is requested in the measurement configuration establishment request frame.

In an example, the sensing setup command field takes a value of 0 to indicate that the measurement configuration is accepted; and the sensing setup command field takes a value of 1 to indicate that the measurement configuration is rejected.

A reason code field is configured to indicate a reason of the device disagreeing with the measurement configuration that is requested in the measurement configuration establishment request frame.

The reason code field is present when the value of the sensing setup command indicates that the measurement configuration is rejected. When the value of the sensing setup command indicates that the measurement configuration is accepted, the reason code field is not present.

In an example, the reason code field takes a value of 0 to indicate that the type of the measurement result corresponding to the measurement configuration requested in the sensing session establishment request is not supported. The reason code field takes a value of 1 to indicate that the role corresponding to the measurement configuration requested in the sensing session establishment request is not supported. The reason code field takes a value of 2 to indicate that the bandwidth corresponding to the measurement configuration requested in the sensing session establishment request is not supported. The reason code field takes a value of 3 to indicate that the number of antennas corresponding to the measurement configuration requested in the sensing session establishment request is not supported.

In some embodiments, the third device may carry at least one measurement configuration via the sensing session establishment request frame or the measurement configuration request frame.

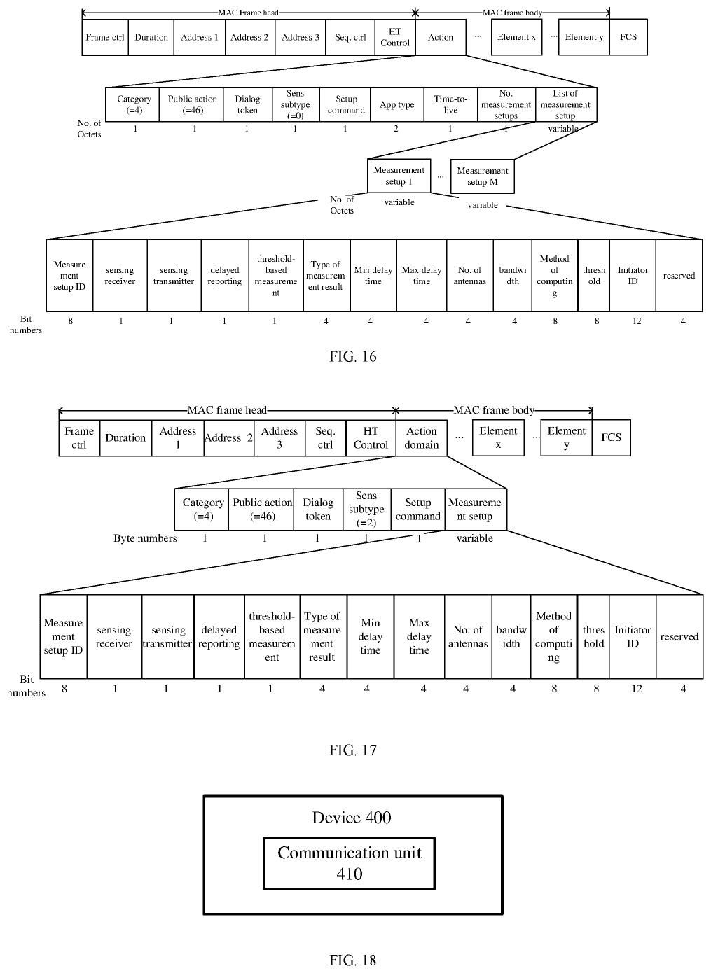

FIG. 16 is a schematic view of a frame format of the sensing session establishment request frame carrying at least one measurement configuration. In the present frame format, the action category field takes the value of 4 to indicate that the frame is the public action frame. The public action field takes the value of 46 to indicate that the frame is the sensing action frame. The SENS subtype field takes the value of 0 to indicate that the frame is the sensing session establishment request frame.

As shown in FIG. 16, the sensing session establishment request frame may include at least one of the following fields.

It should be understood that the correspondence between the meaning and the value of each field is only an example, as long as each meaning corresponds to one value, and the present application is not limited thereto.

The sensing setup command field indicates how the measurement configuration in the sensing session establishment request frame is configured. In an example, the sensing setup command field takes a value of 0 to indicate that the measurement configuration is configured based on demands; and the sensing setup command field takes a value of 0 to indicate that the measurement configuration is configured based on suggests.

An application type field is configured to indicate the application type of the sensing session.

In an example, the application type field takes a value of 0 to indicate detecting presence of a person; the application type field takes a value of 1 to indicate detecting the number of persons; the application type field takes a value of 2 to indicate detecting a location of the person; the application type field takes a value of 3 to indicate detecting a posture of the person; the application type field takes a value of 4 to indicate detecting vital signs; and the application type field takes a value of 5 to indicate detecting sleeping.

A time-to-live field is configured to indicate the time-to-live of the sensing session. When the time-to-live is expired, the session is terminated automatically.

In an example, the time-to-live field takes a value of 1 to indicate 1 minute; the time-to-live field takes a value of 2 to indicate 10 minutes; the time-to-live field takes a value of 3 to indicate 1 hour; the time-to-live field takes a value of 4 to indicate 12 hours, and so on.

The number-of-measurement field is configured to indicate the number of measurement configurations included in the measurement configuration list field.

The measurement configuration field is configured to indicate the measurement configuration identifier and the operational parameter corresponding to the measurement configuration identifier.

The measurement configuration ID field is configured to indicate the identifier of the measurement configuration.

The field of whether being the sensing receiver is configured to indicate whether the peer device serves as the sensing receiver in the measurement.

In an example, the field of whether being the sensing receiver takes a value of 1 to indicate that the peer device serves as the sensing receiver in the measurement; and the field of whether being the sensing receiver takes a value of 0 to indicate that the peer device does not serve as the sensing receiver in the measurement. Alternatively, the field of whether being the sensing receiver takes a value of 0 to indicate that the peer device serves as the sensing receiver in the measurement; and the field of whether being the sensing receiver takes a value of 1 to indicate that the peer device does not serve as the sensing receiver in the measurement

A field of whether being the sensing transmitter is configured to indicate whether the peer device serves as the sensing transmitter in the measurement.

In an example, the field of whether being the sensing transmitter takes a value of 1 to indicate that the peer device serves as the sensing transmitter in the measurement; and the field of whether being the sensing transmitter takes a value of 0 to indicate that the peer device does not serve as the sensing transmitter in the measurement. Alternatively, the field of whether being the sensing transmitter takes a value of 0 to indicate that the peer device serves as the sensing transmitter in the measurement; and the field of whether being the sensing transmitter takes a value of 1 to indicate that the peer device does not serve as the sensing transmitter in the measurement

The field of whether to delay reporting the measurement result is configured to indicate whether the peer device delays reporting of the measurement result.

In an example, the field of whether to delay reporting the measurement result takes a value of 1 to indicate that the peer device delays reporting of the measurement result; and the field of whether to delay reporting the measurement result takes a value of 0 to indicate that the peer device reports the measurement result without delay. Alternatively, the field of whether to delay reporting the measurement result takes a value of 0 to indicate that the peer device delays reporting of the measurement result; and the field of whether to delay reporting the measurement result takes a value of 1 to indicate that the peer device reports the measurement result without delay.

The field of whether the measurement being threshold-based is configured to indicate whether the measurement is a threshold-based measurement.

In an example, the field of whether the measurement being threshold-based takes a value of 1 to indicate that the measurement is the threshold-based measurement; and the field of whether the measurement being threshold-based takes a value of 0 to indicate that the measurement is not the threshold-based measurement. Alternatively, the field of whether the measurement being threshold-based takes a value of 0 to indicate that the measurement is the threshold-based measurement; and the field of whether the measurement being threshold-based takes a value of 1 to indicate that the measurement is not the threshold-based measurement.

The measurement result type field is configured to indicate the data type of the measurement result.

In an example, the measurement result type field takes a value of 0 to indicate the measurement result in the CSI-type; the measurement result type field takes a value of 1 to indicate the measurement result in the RSSI-type; the measurement result type field takes a value of 2 to indicate the measurement result in the beam SNR-type; and the measurement result type field takes a value of 3 to indicate the measurement result in the TCIR-type.

The minimum delay time field is configured to indicate that the peer device needs to report the sensing result after the minimum delay time.

In an example, the minimum delay time field takes a value of 0 to indicate 1 SIFS; the minimum delay time field takes a value of 1 to indicate 2 SIFS; the minimum delay time field takes a value of 3 to indicate 4 SIFS; the minimum delay time field takes a value of 4 to indicate 8 SIFS; the minimum delay time field takes a value of 5 to indicate 1 TU (generally 1 ms); the minimum delay time field takes a value of 6 to indicate 2 TUs; and so on.

The maximum delay time field is configured to indicate that the peer device needs to report the sensing result before the maximum delay time. In an example, the maximum delay time field takes a value of 0 to indicate 1 SIFS; the maximum delay time field takes a value of 1 to indicate 2 SIFS; the maximum delay time field takes a value of 3 to indicate 4 SIFS; the maximum delay time field takes a value of 4 to indicate 8 SIFS; the maximum delay time field takes a value of 5 to indicate 1 TU (generally 1 ms); the maximum delay time field takes a value of 6 to indicate 2 TUs; and so on.

The number-of-antenna field is configured to indicate the number of antennas used for the measurement, such as 1 to 16 antennas.

The bandwidth field is configured to indicate the bandwidth used for the measurement.

In an example, the bandwidth field takes a value of 1 to indicate 20 MHz; the bandwidth field takes a value of 2 to indicate 40 MHz; the bandwidth field takes a value of 3 to indicate 80 MHz; the bandwidth field takes a value of 4 to indicate 160 MHz; and the bandwidth field takes a value of 5 to indicate 320 MHz.

A method-of-computing field is configured to indicate the method of computing the threshold.

In an example, the method-of-computing field takes a value of 0 to indicate time-reversal resonating strength (TRRS); the method-of-computing field takes a value of 1 to indicate scalar differential, and so on.

The threshold field is configured to indicate the threshold data.

The sensing initiator identifier field is configured to indicate an identifier of the sensing initiator, such as an AID or a UID, and so on.

As shown in FIG. 17, the measurement configuration establishment request frame may include at least one of the following fields:

It should be understood that the correspondence between the meaning and the value of each field is only an example, as long as each meaning corresponds to one value, and the present application is not limited thereto.

The sensing setup command field is configured to indicate how the measurement configuration in the measurement configuration establishment request frame is configured. In an example, the sensing setup command field takes a value of 0 to indicate that the measurement configuration is configured by demands; and the sensing setup command field takes a value of 1 to indicate that the measurement configuration is configured by suggest.

The application type field is configured to indicate the type of the application of the sensing session.

In an example, the application type field takes a value of 0 to indicate detecting presence of a person; the application type field takes a value of 1 to indicate detecting the number of persons; the application type field takes a value of 2 to indicate detecting a location of the person; the application type field takes a value of 3 to indicate detecting a posture of the person; the application type field takes a value of 4 to indicate detecting vital signs; and the application type field takes a value of 5 to indicate detecting sleeping.

The time-to-live field is configured to indicate a time-to-live of the sensing session. When the time-to-live is expired, the sensing session is terminated automatically.

In an example, the time-to-live field takes a value of 1 to indicate 1 minute; the time-to-live field takes a value of 2 to indicate 10 minutes; the time-to-live field takes a value of 3 to indicate 1 hour; the time-to-live field takes a value of 4 to indicate 12 hours, and so on.

The measurement configuration field is configured to indicate the measurement configuration identifier and the operational parameter corresponding to the measurement configuration identifier.

The measurement configuration ID field is configured to indicate the identifier of the measurement configuration.

The field of whether being the sensing receiver is configured to indicate whether the peer device serves as the sensing receiver during the measurement.

In an example, the field of whether being the sensing receiver takes a value of 1 to indicate that the peer device serves as the sensing receiver during the measurement; and the field of whether being the sensing receiver takes a value of 0 to indicate that the peer device does not serve as the sensing receiver during the measurement. Alternatively, the field of whether being the sensing receiver takes a value of 0 to indicate that the peer device serves as the sensing receiver during the measurement; and the field of whether being the sensing receiver takes a value of 1 to indicate that the peer device does not serve as the sensing receiver during the measurement.

The field of whether being the sensing transmitter is configured to indicate whether the peer device serves as the sensing transmitter during the measurement.

In an example, the field of whether being the sensing transmitter takes a value of 1 to indicate that the peer device serves as the sensing transmitter during the measurement; and the field of whether being the sensing transmitter takes a value of 0 to indicate that the peer device does not serve as the sensing transmitter during the measurement. Alternatively, the field of whether being the sensing transmitter takes a value of 0 to indicate that the peer device serves as the sensing transmitter during the measurement; and the field of whether being the sensing transmitter takes a value of 1 to indicate that the peer device does not serve as the sensing transmitter during the measurement.

The delayed report field is configured to indicate whether the peer device delays reporting of the measurement result.

In an example, the delayed report field takes a value of 1 to indicate that the peer device delays reporting of the measurement result; and the delayed report field takes a value of 0 to indicate that the peer device reports the measurement result without delay. Alternatively, the delayed report field takes a value of 0 to indicate that the peer device delays reporting of the measurement result; and the delayed report field takes a value of 1 to indicate that the peer device reports the measurement result without delay.

The field of whether the measurement being threshold based is configured to indicate whether the measurement is the threshold-based measurement.

In an example, the field of whether the measurement being threshold based takes a value of 1 to indicate that the measurement is the threshold-based measurement; and the field of whether the measurement being threshold based takes a value of 0 to indicate that the measurement is not the threshold-based measurement. Alternatively, the field of whether the measurement being threshold based takes a value of 0 to indicate that the measurement is the threshold-based measurement; and the field of whether the measurement being threshold based takes a value of 1 to indicate that the measurement is not the threshold-based measurement.

The measurement result type field is configured to indicate the data type of the measurement result.

In an example, the measurement result type field takes a value of 0 to indicate the measurement result in the CSI type; the measurement result type field takes a value of 1 to indicate the measurement result in the RSSI type; the measurement result type field takes a value of 2 to indicate the measurement result in the beam SNR type; the measurement result type field takes a value of 3 to indicate the measurement result in the TCIR type, and so on.

The minimum delay time field is configured to indicate that the peer device needs to report the sensing result after the minimum delay time.

In an example, the minimum delay time field takes a value of 0 to indicate 1 SIFS; the minimum delay time field takes a value of 1 to indicate 2 SIFS; the minimum delay time field takes a value of 3 to indicate 4 SIFS; the minimum delay time field takes a value of 4 to indicate 8 SIFS; the minimum delay time field takes a value of 5 to indicate 1 TU (generally Ims); and the minimum delay time field takes a value of 6 to indicate 2 TUs, and so on.

The maximum delay time field is configured to indicate that the peer device needs to report the sensing result before the maximum delay time. In an example, the maximum delay time field takes a value of 0 to indicate 1 SIFS; the maximum delay time field takes a value of 1 to indicate 2 SIFS; the maximum delay time field takes a value of 3 to indicate 4 SIFS; the maximum delay time field takes a value of 4 to indicate 8 SIFS; the maximum delay time field takes a value of 5 to indicate 1 TU (generally 1 ms); the maximum delay time field takes a value of 6 to indicate 2 TUs, and so on.

The number-of-antenna field is configured to indicate the number of antennas used for the measurement, such as 1 to 16 antennas.

The bandwidth field is configured to indicate the bandwidth used for the measurement.

As an example, the bandwidth field takes a value of 1 to indicate 20 MHz; the bandwidth field takes a value of 2 to indicate 40 MHz; the bandwidth field takes a value of 3 to indicate 80 MHz; the bandwidth field takes a value of 4 to indicate 160 MHz; and the bandwidth field takes a value of 5 to indicate 320 MHz.

The method-of-computing field is configured to indicate the method of computing the threshold.

As an example, the method-of-computing field takes a value of 0 to indicate time-reversal resonating strength (TRRS), the method-of-computing field takes a value of 1 to indicate Scalar Differential, and so on.

The threshold field is configured to indicate the threshold data.

The sensing initiator identifier field is configured to indicate the identifier of the sensing initiator, such as an AID or a UID, and so on.

It should be noted that the bit number in FIG. 6-FIG. 17 generally refers to the number of bits, and the byte number generally refers to the number of octets.

In some embodiments, during the sensing measurement stage, a non-trigger based (non-TB) measurement process may be performed when only one pair of devices perform the sensing measurement.

In some scenarios, it needs to be detected whether the device that performs the measurement is available. For example, a sensing receiver supporting dual band single concurrent (DBSC) may be temporarily unavailable due to band switching. Therefore, checking the availability of the pair of devices is necessary.

In some implementations, when the AP is the sensing transmitter and the non-AP STA is the sensing receiver, the AP needs to send a sensing poll trigger frame (SENS TF Poll) to detect the availability of the sensing receiver device before sending a null data PPDU announcement (NDPA).

In some implementations, when the non-AP STA is the sensing transmitter and the AP is the sensing receiver, the availability of the sensing receiver may not be detected before the NDPA is sent.

In some embodiments, during the sensing reporting stage, when the measurement result is to be reported in a delayed manner, an explicit or implicit solicited report may be applied.

In some embodiments, an unsolicited report may be applied. That is, the sensing receiver decides on its own a time point of reporting the sensing result, without being requested or triggered by the sensing transmitter (or the sensing initiator, or the AP device).

In some embodiments, when the unsolicited report is applied, the sensing receiver needs to report the sensing result after the above-mentioned minimum delay time.

In some embodiments, when the unsolicited report is applied, the sensing receiver needs to report the sensing result before the above-mentioned maximum delay time.

In some embodiments, when the solicited report is applied, and when the sensing receiver does not report the measurement result before the maximum delay time, which may be caused by occurrence of an error, termination of an application, the device entering a sleeping mode, and so on, the sensing receiver discards the corresponding measurement result.

In summary, in the embodiments of the present disclosure, one or more measurement configurations may be stored in the device in advance. In this way, when the sensing measurement configuration is being established, the devices only need to interact with each other about the identifier of the to-be-established measurement configuration without interacting about specific operational parameter. For example, when the sensing session or the measurement configuration is being established, at least one measurement configuration identifier is interacted, such that the signaling overhead is reduced, and the process of establishing the measurement configuration is speeded up.

In some embodiments, the devices may also interact with each other about the sensing capability information. For example, the sensing capability information is interacted during the discovery stage, and the sensing capability information may be used to determine the operational parameter in the measurement configuration.

Further, in the sensing measurement stage, the AP device may detect, by sending the SENS TF Poll, whether the sensing receiver is available to improve the sensing performance. In the sensing reporting stage, the sensing receiver may report the measurement result by performing the unsolicited report method. For example, the sensing receiver reports the measurement result based on delay time information in the measurement configuration.

Method embodiments of the present disclosure are described in detail above by referring to FIG. 3 to FIG. 17, and device embodiments of the present disclosure will be described in detail below by referring to FIG. 18 to FIG. 23, and it should be understood that the device embodiments and the method embodiments correspond to each other, and similar descriptions may be referred to the method embodiments.

FIG. 18 illustrates a schematic block diagram of a wireless communication device 400 according to an embodiment of the present disclosure. As shown in FIG. 18, the device 400 includes the following.

A communication unit 410 is configured to receive at least one measurement configuration identifier sent by the second device. Each measurement configuration identifier corresponds to a set of operational parameters to perform the sensing measurement.

In some embodiments of the present disclosure, the set of operational parameters for the sensing measurement includes at least one of the following:

Role information of the device in the sensing measurement, the number of antennas used for the sensing measurement, the bandwidth used for the sensing measurement, the type of the measurement result, the type of how to report the measurement result, and threshold setup information.

In some embodiments of the present disclosure, the second device is the sensing session initiator or the proxy device of the sensing session initiator.

In some embodiments of the present disclosure, the device is the sensing responder.

In some embodiments of the present disclosure, the at least one measurement configuration identifier is sent by the second device via the first request frame. The first request frame is configured to request establishing the sensing session.

In some embodiments of the present disclosure, the first request frame includes at least one measurement configuration field. The measurement configuration field includes a measurement configuration identifier field. The measurement configuration identifier is configured to indicate the measurement configuration identifier corresponding to the measurement configuration that is requested to be established by the sensing session initiator.

In some embodiments of the present disclosure, the measurement configuration field further includes a sensing initiator identifier to indicate an identifier of the device that requests establishing the sensing session.

In some embodiments of the present disclosure, the at least one measurement configuration identifier is sent by the second device via the second request frame. The second request frame is configured to request establishing the measurement configuration.

In some embodiments of the present disclosure, the second request frame includes at least one measurement configuration field. The measurement configuration field includes a measurement configuration identifier field, the measurement configuration identifier is configured to indicate the measurement configuration identifier corresponding to the measurement configuration that is requested to be established by the sensing session initiator.

In some embodiments of the present disclosure, the measurement configuration field further includes the sensing initiator identifier to indicate the identifier of the device that requests establishing the sensing session.

In some embodiments of the present disclosure, the communication unit 410 is further configured to performing the following.

The communication unit 410 sends, to the second device, a response information of the operational parameters corresponding to the at least one measurement configuration identifier.

In some embodiments of the present disclosure, the response information is configured to indicate at least one of the following:

Whether the device agreeing with the operational parameters corresponding to the at least one measurement configuration identifier, a reason of the device disagreeing with the operational parameters corresponding to the at least one measurement configuration identifier.

In some embodiments of the present disclosure, the at least one measurement configuration identifier is sent via the first request frame. The response information is sent via the first response frame. The first response frame is a response frame for the first request frame. The first request frame is configured to request establishing the sensing session.

In some embodiments of the present disclosure, the first response frame includes the sensing setup command field and/or the reason code field. The sensing setup command field is configured to indicate whether the device agrees with the operational parameters corresponding to the at least one measurement configuration identifier. The reason code field is configured to indicate a reason of the device disagreeing with the operational parameters corresponding to the at least one measurement configuration identifier.

In some embodiments of the present disclosure, the at least one measurement configuration identifier is sent via the second request frame, and the response information is sent via the second response frame. The second response frame is a response frame for the second request frame. The second request frame is configured to request establishing the measurement configuration.

In some embodiments of the present disclosure, the second response frame includes the sensing setup command field and/or the reason code field. The sensing setup command field is configured to indicate whether the device agrees with the operational parameters corresponding to the at least one measurement configuration identifier. The reason code field is configured to indicate a reason of the device disagreeing with the operational parameters corresponding to the at least one measurement configuration identifier.

In some embodiments of the present disclosure, the first request frame is the action frame or the action no acknowledgement (ACK) frame.

In some embodiments of the present disclosure, the first request frame includes an action field. The action field includes the action category field, the public action field, and the sensing subtype field. A value of the action category field, a value of the public action field, and a value of the sensing subtype field are cooperatively used to indicate that the first request frame is the session establishment request frame.

In some embodiments of the present disclosure, the first response frame is the action frame or the action no ACK frame.

In some embodiments of the present disclosure, the first response frame includes the action field. The action field includes the action category field, the public action field, and the sensing subtype field. A value of the action category field, a value of the public action field, and a value of the sensing subtype field are cooperatively used to indicate that the first response frame is the session establishment response frame.

In some embodiments of the present disclosure, the second request frame is the action frame or the action no ACK frame.

In some embodiments of the present disclosure, the second request frame includes the action field. The action field includes the action category field, the public action field, and the sensing subtype field. A value of the action category field, a value of the public action field, and a value of the sensing subtype field are cooperatively used to indicate that the second request frame is the measurement configuration establishment request frame.

In some embodiments of the present disclosure, the second response frame is the action frame or the action no ACK frame.

In some embodiments of the present disclosure, the second response frame includes the action field, the action field includes the action category field, the public action field, and the sensing subtype field. A value of the action category field, a value of the public action field, and a value of the sensing subtype field are cooperatively used to indicate that the second response frame is the measurement configuration establishment response frame.

In some embodiments of the present disclosure, the communication unit 410 is further configured to perform the following.

The communication unit 410 receives at least one measurement configuration sent by the third device. Each measurement configuration includes the measurement configuration identifier and a set of operational parameters for the sensing measurement.

In some embodiments of the present disclosure, the at least one measurement configuration is sent via at least one of the following frames:
The beacon frame, the detection response frame, the association response frame, and the re-association response frame.

In some embodiments of the present disclosure, the third device is the AP device or the non-AP STA device.

In some embodiments, the communication unit may be a communication interface or a transceiver, or an input/output interface of a communication chip or a system-on-chip. The processing unit described in the above may be one or more processors.

It should be understood that the device 400 in the embodiment of the present disclosure may correspond to the first device in the method embodiment of the present disclosure. The above and other operations and/or functions of the various units of the device 400 can implement corresponding processes of the first device in the method 200 shown in FIG. 3 to FIG. 17, respectively; and are not repeated herein for brevity.

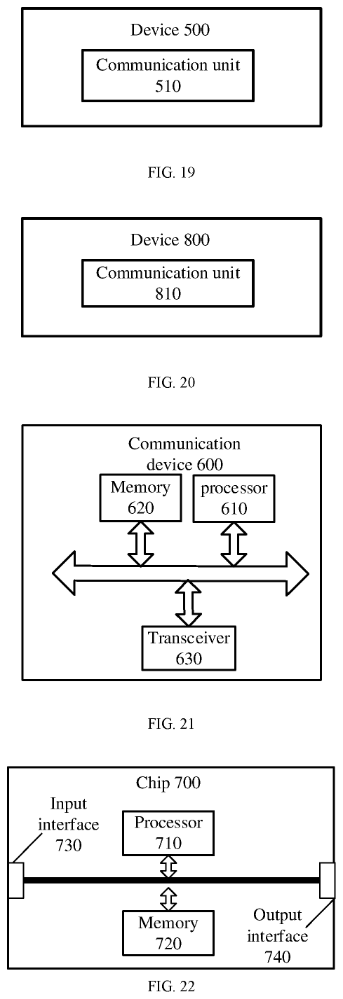

FIG. 19 is a schematic block diagram of a wireless communication device 500 according to an embodiment of the present disclosure. The device 500 of FIG. 19 includes the following.

A communication unit 510 is configured to transmit at least one measurement configuration identifier to at least one first device. Each measurement configuration identifier corresponds to a set of operational parameters for the sensing measurement.

In some embodiments of the present disclosure, the set of operational parameters for the sensing measurement includes at least one of the following:

Role information of the device in the sensing measurement, the number of antennas used for the sensing measurement, the bandwidth used for the sensing measurement, the type of the measurement result, the type of how to report the measurement result, and the threshold setup information.

In some embodiments of the present disclosure, the device is the sensing session initiator or the proxy device of the sensing session initiator.

In some embodiments of the present disclosure, the first device is the sensing responder.

In some embodiments of the present disclosure, the at least one measurement configuration identifier is sent via the first request frame. The first request frame is configured to request establishing the sensing session.

In some embodiments of the present disclosure, the first request frame includes at least one measurement configuration field. Each measurement configuration field includes the measurement configuration identifier field, the measurement configuration identifier is configured to indicate the measurement configuration identifier corresponding to the measurement configuration that is requested to be established by the sensing session initiator.

In some embodiments of the present disclosure, the measurement configuration field further includes the sensing initiator identifier to indicate the identifier of the device that requests establishing the sensing session.

In some embodiments of the present disclosure, the at least one measurement configuration identifier is sent via the second request frame. The second request frame is configured to request establishing the measurement configuration.

In some embodiments of the present disclosure, the second request frame includes at least one measurement configuration field. Each measurement configuration field includes the measurement configuration identifier field, the measurement configuration identifier is configured to indicate the measurement configuration identifier corresponding to the measurement configuration that is requested by the sensing session initiator to be established.

In some embodiments of the present disclosure, the measurement configuration field further includes the sensing initiator identifier to indicate the identifier of the device that requests establishing the sensing session.

In some embodiments of the present disclosure, the communication unit 510 is further to perform the following.

The communication unit 510 receives the response information, which is sent by at least one first device, for the operational parameters corresponding to the at least one measurement configuration identifier.

In some embodiments of the present disclosure, the response information is configured to indicate at least one of the following:

Whether the first device agreeing with the operational parameters corresponding to the at least one measurement configuration identifier, the reason of the first device disagreeing with the operational parameters corresponding to the at least one measurement configuration identifier.

In some embodiments of the present disclosure, the at least one measurement configuration identifier is sent via the first request frame, and the response message is sent via the first response frame. The first response frame is a response frame for the first request frame. The first request frame is configured to request establishing the sensing session.

In some embodiments of the present disclosure, the first response frame includes the sensing setup command field and/or the reason code field. The sensing setup command field is configured to indicate whether the first device agrees with the operational parameters corresponding to the at least one measurement configuration identifier. The reason code field is configured to indicate the reason of the first device disagreeing with the operational parameters corresponding to the at least one measurement configuration identifier.

In some embodiments of the present disclosure, the at least one measurement configuration identifier is sent via the second request frame, and the response message is sent via the second response frame. The second response frame is a response frame for the second request frame. The second request frame is configured to request establishing the measurement configuration.

In some embodiments of the present disclosure, the second response frame includes the sensing setup command field and/or the reason code field. The sensing setup command field is configured to indicate whether the first device agrees with the operational parameters corresponding to the at least one measurement configuration identifier. The reason code field is configured to indicate a reason of the first device disagreeing with the operational parameters corresponding to the at least one measurement configuration identifier.

In some embodiments of the present disclosure, the first request frame is the action frame or the action no ACK frame.

In some embodiments of the present disclosure, the first request frame includes the action field, the action field includes the action category field, the public action field, and the sensing subtype field. A value of the action category field, a value of the public action field, and a value of the sensing subtype field are cooperatively used to indicate that the first request frame is the session establishment request frame.

In some embodiments of the present disclosure, the first response frame is the action frame or the action no ACK frame.

In some embodiments of the present disclosure, the first response frame includes the action field, the action field includes the action category field, the public action field, and the sensing subtype field. A value of the action category field, a value of the public action field, and a value of the sensing subtype field are cooperatively used to indicate that the first response frame is the session establishment response frame.

In some embodiments of the present disclosure, the second request frame is the action frame or the action no ACK frame.

In some embodiments of the present disclosure, the second request frame includes the action field, the action field includes the action category field, the public action field, and the sensing subtype field. A value of the action category field, a value of the public action field, and a value of the sensing subtype field are cooperatively used to indicate that the second request frame is the measurement configuration establishment request frame.

In some embodiments of the present disclosure, the second response frame is the action frame or the action no ACK frame.

In some embodiments of the present disclosure, the second response frame includes the action field, the action field includes the action category field, the public action field, and the sensing subtype field. A value of the action category field, a value of the public action field, and a value of the sensing subtype field are cooperatively used to indicate that the second response frame is the measurement configuration establishment response frame.

In some embodiments of the present disclosure, the communication unit 510 is further configured to perform the following.

The communication unit 510 sends at least one measurement configuration to at least one device. Each measurement configuration includes the measurement configuration identifier and a set of operational parameters for the sensing measurement. The at least one device includes the at least one first device.

In some embodiments of the present disclosure, the at least one measurement configuration is sent via at least one of the following frames:
The beacon frame, the detection response frame, the association response frame, and the re-association response frame.

In some embodiments, the communication unit may be a communication interface or a transceiver, or an input/output interface of a communication chip or a system-on-chip. The processing unit described in the above may be one or more processors.

It should be understood that the device 500 in the embodiment of the present disclosure may correspond to the second device in the method embodiment of the present disclosure. The above and other operations and/or functions of the various units of the device 500 can implement corresponding processes of the first device in the method 200 shown in FIG. 3 to FIG. 17, respectively; and are not repeated herein for brevity.

FIG. 20 is a schematic block diagram of a wireless communication device according to embodiments of the present disclosure. The device 800 in FIG. 20 includes the following.

A communication unit 810 is configured to send at least one measurement configuration to at least one device. Each measurement configuration includes a measurement configuration identifier and a set of operational parameters for the sensing measurement.

In some embodiments of the present disclosure, the set of operational parameters for the sensing measurement includes at least one of the following:

Role information of the device in the sensing measurement, the number of antennas used for the sensing measurement, the bandwidth used for the sensing measurement, the type of the measurement result, the type of how to report the measurement result, and the threshold setup information.

In some embodiments of the present disclosure, the at least one measurement configuration is sent via at least one of the following frames:
The beacon frame, the detection response frame, the association response frame, and the re-association response frame.

In some embodiments of the present disclosure, the device is the AP device or the non-AP STA device.

In some embodiments of the present disclosure, the at least one device includes the non-AP STA device and/or the AP device.

In some embodiments, the communication unit may be a communication interface or a transceiver, or an input/output interface of a communication chip or a system-on-chip. The processing unit described in the above may be one or more processors.

It should be understood that the device 800 in the embodiment of the present disclosure may correspond to the third device in the method embodiment of the present disclosure. The above and other operations and/or functions of the various units of the device 800 can implement corresponding processes of the first device in the method 200 shown in FIG. 3 to FIG. 17, respectively; and are not repeated herein for brevity.

FIG. 21 is a schematic structural diagram of a communication device 600 according to an embodiment of the present disclosure. The communication device 600 shown in FIG. 21 includes a processor 610, which may invoke and run a computer program from a memory to implement the method in the embodiments of the present disclosure.

In some embodiments, as shown in FIG. 21, the communication device 600 may further include a memory 620. The processor 610 may invoke and run a computer program from the memory 620 to implement the method in the embodiments of the present disclosure.

The memory 620 may be a component independent from the processor 610 or may be integrated into the processor 610.

In some embodiments, as shown in FIG. 21, the communication device 600 may further include a transceiver 630. The processor 610 controls the transceiver 630 to communicate with other devices, specifically, to send information or data to other devices or to receive information or data sent from the other devices.

The transceiver 630 may include a transmitter and a receiver. The transceiver 630 may further include an antenna, and the number of antennas may be one or more.

In some embodiments, the communication device 600 may specifically be the first device in the embodiments of the present disclosure. The communication device 600 may perform corresponding processes performed by the first device in the method embodiments of the present disclosure, which will not be repeated herein.

In some embodiments, the communication device 600 may specifically be a second device of the embodiments of the present disclosure. The communication device 600 may perform corresponding processes performed by the second device in the various method embodiments of the present disclosure, which will not be repeated herein.

In some embodiments, the communication device 600 may specifically be the third device in the embodiments of the present disclosure. The communication device 600 may perform corresponding processes performed by the third device in the respective method embodiments of the present disclosure, which will not be repeated herein.

FIG. 22 is a schematic structural diagram of a chip according to an embodiment of the present disclosure. The chip 700 shown in FIG. 22 includes a processor 710. The processor 710 may invoke and run a computer program from the memory to implement the methods in the embodiments of the present disclosure.

In some embodiments, as shown in FIG. 22, the chip 700 may further include a memory 720. The processor 710 may invoke and run the computer program from the memory 720 to implement the method in the embodiments of the present disclosure.

The memory 720 may be a component independent from the processor 710 or may be integrated into the processor 710.

In some embodiments, the chip 700 may further include an input interface 730. The processor 710 may control the input interface 730 to communicate with other devices or chips, specifically, to obtain information or data sent by other devices or chips.

In some embodiments, the chip 700 may further include an output interface 740. The processor 710 may control the output interface 740 to communicate with other devices or chips, specifically, to output information or data to other devices or chips.

In some embodiments, the chip may be applied to the first device in the embodiments of the present application. The chip may perform the corresponding processes performed by the first device in the various method embodiments of the present application, which will not be repeated herein.

In some embodiments, the chip can be applied to the second device in the embodiments of the present application. The chip can perform the corresponding processes performed by the second device in the various method embodiments of the present disclosure, which are not repeated herein.

In some embodiments, the chip may be applied to the third device in the embodiments of the present disclosure. The chip may perform the corresponding processes performed by the third device in the respective method embodiments of the present disclosure, which will not be repeated herein.

It should be understood that the chip referred to in the embodiments of the present disclosure may be referred to as a system chip, a system-on-chip, a chip system or a chip of system-on-chip, and the like.

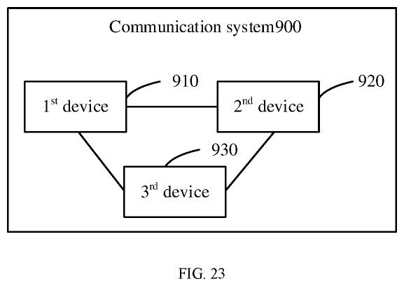

FIG. 23 is a schematic block diagram of a communication system 900 according to an embodiment of the present disclosure. As shown in FIG. 23, the communication system 900 includes a first device 910, a second device 920, and a third device 930.

The first device 910 may be configured to perform corresponding functions achieved by the first device in the above method embodiments, the second device 920 may be configured to perform corresponding functions achieved by the second device in the above method embodiments, and the third device 930 may be configured to perform corresponding functions achieved by the third device in the above method embodiments, which will not be repeated herein.

It should be understood that the processor of the embodiment of the present disclosure may be an integrated circuit chip having signal processing capabilities. In practice, the operations of the above method embodiments may be performed by integrated logic circuits of hardware in the processor or by instructions in the form of software. The above-described processor may be a general-purpose processor, a digital signal processor (DSP), an application specific integrated circuit (ASIC), a field programmable gate array (FPGA), or other programmable logic devices, a discrete gate or a transistor logic device, and a discrete hardware component. Various methods, operations, and logic block diagrams of the present disclosure may be implemented or performed. The general purpose processor may be a microprocessor or any conventional processor. The operations of the method disclosed by referring to the embodiments of the present disclosure may be directly performed by a hardware decoding processor or performed by combination of hardware and software modules in a decoding processor. The software module may be located in a random memory, a flash memory, a read-only memory, a programmable read-only memory or an electrically erasable programmable memory, a register, and other storage media that are well established in the art. The storage medium is located in a memory, and the processor reads the information from the memory and completes the operations of the method described in the above based on combination with hardware.

It will be appreciated that the memory in the embodiments of the present disclosure may be a volatile memory or a non-volatile memory, or may include both volatile and non-volatile memories. The non-volatile memory may be a read-only memory (ROM), a programmable ROM (PROM), an Erasable Programmable Read-Only Memory (EPROM), an electrically erasable programmable read-only memory (EEPROM), or a flash memory. The volatile memory may be a random access memory (RAM), which is used as an external cache. For example, but not limitation, various forms of RAMs are available, such as a static random access memory (SRAM), a dynamic random access memory (DRAM), a synchronous DRAM (SDRAM), a double data rate SDRAM (DDR SDRAM), a double data rate SDRAM (DDR SDRAM), an Enhanced Synchronous SDRAM (ESDRAM), a Synchlink DRAM (SLDRAM), and a direct random access memory (DRAM). It should be noted that the memory of the systems and the method described herein is intended to include, but is not limited to, the above and any other suitable types of memories.

It should be understood that the above memories are exemplary but not limiting description. For example, the memories in the embodiments of the present disclosure may be a static Random Access Memory (static RAM, SRAM), a dynamic random access memory (DRAM), a synchronous DRAM (SDRAM), a double data rate SDRAM (DDR SDRAM), an enhanced SDRAM, a synch link DRAM (SLDRAM), and a direct random access memory (DRAM). That is, the memory in the embodiments of the present disclosure is intended to include, but is not limited to, the above and any other suitable types of memories.

The present disclosure further provides a computer-readable storage medium for storing a computer program.

In some embodiments, the computer-readable storage medium may be applied to the first device in the embodiments of the present disclosure, and the computer program causes the computer to execute the corresponding processes performed by the first device in the various method embodiments of the present disclosure, which are not described herein.

In some embodiments, the computer-readable storage medium may be applied to the second device in the embodiments of the present disclosure, and the computer program causes the computer to execute the corresponding processes performed by the second device in the various method embodiments of the present disclosure, which are not described herein.

In some embodiments, the computer-readable storage medium may be applied to the third device in the embodiments of the present disclosure, and the computer program causes the computer to execute the corresponding processes performed by the third device in the various method embodiments of the present disclosure, which are not described herein.

The present disclosure further provides a computer program product including computer program instructions.

In some embodiments, the computer program product may be applied to the first device in the embodiments of the present disclosure, and the computer program instructions cause the computer to execute the corresponding processes performed by the first device in the various method embodiments of the present disclosure, which are not repeated herein.

In some embodiments, the computer program product may be applied to the second device in the embodiments of the present disclosure, and the computer program instructions cause the computer to execute the corresponding processes performed by the second device in the various method embodiments of the present disclosure, which are not repeated herein.

In some embodiments, the computer program product may be applied to the third device in the embodiments of the present disclosure, and the computer program instructions cause the computer to execute the corresponding processes performed by the third device in the various method embodiments of the present disclosure, which are not repeated herein.

The present disclosure further provides a computer program.

In some embodiments, the computer program may be applied to the first device in the embodiments of the present disclosure. When the computer program is run on the computer, it causes the computer to execute the corresponding processes performed by the first device in the various method embodiments of the present disclosure, which will not be repeated herein.

In some embodiments, the computer program may be applied to the second device in the embodiments of the present disclosure. When the computer program is run on the computer, it causes the computer to execute the corresponding processes performed by the second device in the various method embodiments of the present disclosure, which will not be repeated herein.

In some embodiments, the computer program may be applied to the third device in the embodiments of the present disclosure. When the computer program is run on the computer, it causes the computer to execute the corresponding processes performed by the third device in the various method embodiments of the present disclosure, which will not be repeated herein.

Any ordinary skilled person in the art may realize that units and algorithmic operations of the various examples described by referring to the embodiments herein can be implemented by electronic hardware or by combination of computer software and the electronic hardware. It is determined, based on particular applications and design constraints of the technical solution, whether these functions are performed by the hardware or the software. Any ordinary skilled person in the art may use different methods to implement the described functions for each particular application, and such implementation shall not be considered outside the scope of the present disclosure.

Any ordinary skilled person in the art shall understand that, for the convenience and brevity, the specific operation processes of the above-described systems, devices, and units can be referred to corresponding processes in the above method embodiments, which will not be repeated herein.

In the several embodiments of the present disclosure, it shall be understood that the systems, devices and methods can be implemented in other ways. For example, the device embodiments described above are merely schematic. For example, the units are divided merely based on logical functions. In practice, the units may be divided in other ways. For example, multiple units or components may be combined or may be integrated into another system, or some features may be omitted or not implemented. In another aspect, coupling or direct coupling or communicative connection shown or discussed may be indirect coupling or communicative connection through some interfaces, devices or units, which may be electrical, mechanical or otherwise.

The units described illustrated as separated components may be or may not be physically separated from each other. The components shown as units may be or may not be physical units, i.e., the units may be located in one place or may be distributed over a plurality of network units. Some or all of these units may be selected to achieve the purpose of the present embodiment according to practical demands.

In addition, each functional unit in various embodiments of the present disclosure may be integrated in a single processing unit, or each unit may be physically present separately, or two or more units may be integrated in one unit.

The functions may be stored in a computer-readable storage medium when implemented in the form of a software functional unit and sold or used as a stand-alone product.

Based on this understanding, the technical solution of the present disclosure may be embodied in the form of a software product, which is essentially or in part a contribution to the related art, or part of the technical solution may be embodied in the form of a software product that is stored in a storage medium and includes a number of instructions to cause a computer device (which may be a personal computer, a server, or a network device, and so on) to perform all or some of the operations of the method described in the various embodiments of the present disclosure. The above-mentioned storage medium includes a USB flash drive, a removable hard disk, a read-only memory (ROM), a random access memory (RAM), a magnetic disc or a compact disc, and other media that can store program codes.

The above description is only a specific embodiment of the present disclosure, but the scope of the present disclosure is not limited thereto. Any skilled person in the art can easily obtain variations or substitutions within the scope of the present disclosure. All of the variations or substitutions shall be covered by the scope of the present disclosure. Therefore, the scope of the present disclosure shall be subject to the scope of the appended claims.

What is claimed is:

1. A wireless communication method, comprising:
receiving, by a first device, at least one measurement configuration identifier sent by a second device; wherein each of the at least one measurement configuration identifier corresponds to a set of operational parameters to perform sensing measurement;
wherein, the set of operational parameters to perform sensing measurement comprises at least one of the following: role information of a device in the sensing measurement, the number of antennas used for the sensing measurement, a bandwidth used for the sensing measurement, a type of a measurement result, a type of how to report the measurement result, and threshold setup information;
the second device is a sensing session initiator or a proxy device of the sensing session initiator; and
the first device is a sensing responder.

2. The wireless communication method according to claim 1, wherein the at least one measurement configuration identifier is sent by the second device via a first request frame, the first request frame is configured to request establishing a sensing session.

3. The wireless communication method according to claim 2, wherein the first request frame comprises at least one measurement configuration field; the measurement configuration field comprises a measurement configuration identifier field; the measurement configuration identifier is configured to indicate a measurement configuration identifier corresponding to a measurement configuration that is requested by a sensing session initiator to be established.

4. The wireless communication method according to claim 3, wherein the measurement configuration field further comprises a sensing initiator identifier to indicate an identifier of a device that requests establishing the sensing session.

5. A wireless communication device, comprising a processor and a memory, wherein the memory is configured to store a computer program, the processor is configured to invoke and run the computer program stored in the memory to perform the operations of:
receiving at least one measurement configuration identifier sent by another device; wherein each of the at least one measurement configuration identifier corresponds to a set of operational parameters to perform sensing measurement;
wherein, the set of operational parameters to perform sensing measurement comprises at least one of the following: role information of a device in the sensing measurement, the number of antennas used for the sensing measurement, a bandwidth used for the sensing measurement, a type of a measurement result, a type of how to report the measurement result, and threshold setup information;
the another device is a sensing session initiator or a proxy device of the sensing session initiator; and
the wireless communication device is a sensing responder.

6. The wireless communication device according to claim 5, wherein, in response to the another device being a sensing transmitter and the wireless communication device being a sensing receiver, the another device is configured to send a sensing poll trigger frame (SENS TF Poll) to detect availability of the wireless communication device before sending a null data PPDU announcement (NDPA).

7. The wireless communication device according to claim 5, wherein, in response to the wireless communication device being a sensing transmitter and the another device being a sensing receiver, availability of the another device is not detected before the wireless communication device sends a null data PPDU announcement (NDPA).

8. The wireless communication device according to claim 5, wherein, sensing capability information is carried in at least one of following elements: a neighbor report element, a radio measurement enabled capabilities element, a reduced neighbor report element, and an extended capabilities element; and the neighbor report element comprises a “whether sensing is supported” field and is configured to indicate whether or not the wireless communication device supports sensing or supports the sensing measurement.

9. The wireless communication device according to claim 8, wherein the extended capabilities element comprises at least one of the following fields:
a max-number-of-antenna field, configured to indicate a maximum number of antennas supported by the wireless communication device; and
a max-bandwidth field, configured to indicate a maximum bandwidth supported by the wireless communication device.

10. The wireless communication device according to claim 5, wherein the at least one measurement configuration identifier is sent by the another device via a first request frame, the first request frame is configured to request establishing a sensing session.

11. The wireless communication device according to claim 10, wherein the first request frame comprises at least one measurement configuration field; the measurement configuration field comprises a measurement configuration identifier field; the measurement configuration identifier is configured to indicate a measurement configuration identifier corresponding to a measurement configuration that is requested by a sensing session initiator to be established.

12. The wireless communication device according to claim 11, wherein the measurement configuration field further comprises a sensing initiator identifier to indicate an identifier of a device that requests establishing the sensing session.

13. A wireless communication device, comprising a processor and a memory, wherein the memory is configured to store a computer program, the processor is configured to invoke and run the computer program stored in the memory to perform the operations of:
sending at least one measurement configuration identifier to at least one another device; wherein each of the at least one measurement configuration identifier corresponds to a set of operational parameters to perform sensing measurement;
wherein, the set of operational parameters to perform sensing measurement comprises at least one of the following: role information of a device in the sensing measurement, the number of antennas used for the sensing measurement, a bandwidth used for the sensing measurement, a type of a measurement result, a type of how to report the measurement result, and threshold setup information;
the wireless communication device is a sensing session initiator or a proxy device of the sensing session initiator; and
the at least one another device is a sensing responder.

14. The wireless communication device according to claim 13, wherein, in response to the wireless communication device being a sensing transmitter and the at least one another device being a sensing receiver, the wireless communication device is configured to send a sensing poll trigger frame (SENS TF Poll) to detect availability of the at least one another device before sending a null data PPDU announcement (NDPA).

15. The wireless communication device according to claim 13, wherein, in response to the at least one another device being a sensing transmitter and the wireless communication device being a sensing receiver, availability of the wireless communication device is not detected before the at least one another device sends a null data PPDU announcement (NDPA).

16. The wireless communication device according to claim 13, wherein, sensing capability information is carried in at least one of following elements: a neighbor report element, a radio measurement enabled capabilities element, a reduced neighbor report element, and an extended capabilities element; and the neighbor report element comprises a “whether sensing is supported” field and is configured to indicate whether or not the wireless communication device supports sensing or supports the sensing measurement.

17. The wireless communication device according to claim 15, wherein the extended capabilities element comprises at least one of the following fields:
a max-number-of-antenna field, configured to indicate a maximum number of antennas supported by the wireless communication device; and
a max-bandwidth field, configured to indicate a maximum bandwidth supported by the wireless communication device.

18. The wireless communication device according to claim 13, wherein the wireless communication device is configured to send the at least one measurement configuration identifier via a first request frame, the first request frame is configured to request establishing a sensing session.

19. The wireless communication device according to claim 18, wherein, the first request frame comprises at least one measurement configuration field; the measurement configuration field comprises a measurement configuration identifier field; the measurement configuration identifier is configured to indicate a measurement configuration identifier corresponding to a measurement configuration that is requested by a sensing session initiator to be established.

20. The wireless communication device according to claim 19, wherein the measurement configuration field further comprises a sensing initiator identifier to indicate an identifier of a device that requests establishing the sensing session.
